(19) United States
(12) Patent Application Publication
(10) Pub. No.: US 2024/0056888 A1
(43) Pub. Date: Feb. 15, 2024

(54) Quality of Service Management for Protocol Data Unit Sets

(71) Applicant: QUALCOMM Incorporated, San Diego, CA (US)

(72) Inventors: Dario Serafino TONESI, San Diego, CA (US); Linhai HE, San Diego, CA (US); Hong CHENG, Basking Ridge, NJ (US); Miguel GRIOT, La Jolla, CA (US)

(21) Appl. No.: 18/446,469

(22) Filed: Aug. 8, 2023

Related U.S. Application Data
(60) Provisional application No. 63/370,916, filed on Aug. 9, 2022.
(60) Provisional application No. 63/370,900, filed on Aug. 9, 2022.

(51) Int. Cl. H04W 28/08; H04W 28/02; H04W 28/24

(52) U.S. Cl. CPC H04W 28/0967; H04W 28/0268; H04W 28/24

(57) ABSTRACT

Apparatuses and methods for managing quality of service for protocol data unit (PDU) Sets include providing alternative service requirements for Protocol Data Unit (PDU) Sets supporting data traffic of an application executing on a user equipment (UE) in which the alternative service requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt. Apparatuses and methods further include adapting parameters for PDU set in response to indications that a link between the UE and the network can no longer guarantee QoS flow transport of the PDU Sets.

### RELATED APPLICATIONS

This application claims the benefit of priority to U.S. Provisional Patent Application No. 63/370,916 entitled “Quality of Service Management for Protocol Data Unit Sets” filed Aug. 9, 2022 and U.S. Provisional Patent Application No. 63/370,900 entitled “Coordinating Rate Adaptation in Wireless Communications” filed Aug. 9, 2022, the entire contents of both of which are incorporated herein by reference for all purposes.

### INTRODUCTION

The following relates generally to wireless communications, and more specifically to quality of service (QoS) management for protocol data unit sets.

In 5G communication systems, a QoS model is based on QoS flows. A QoS flow is the finest level of granularity within a 5G communication system and is the level at which policy and charging are enforced. QoS flow protocol data units (PDUs, e.g., packets) are classified and marked using a unique QoS Flow Identifier. to enable the application of QoS requirement on a data flow.

Some applications that are executed on a network computing device (such as an application server), and corresponding applications that are executed on user equipment (UE), such as an application client (AC), may transmit and receive large amounts of information, such as large amounts of audio, video, or multimedia information, that cannot be conveyed in a single PDU. For such applications, a PDU Set may carry a payload of a unit of information generated by an application. Such applications may be sensitive to QoS requirements, and variations in network conditions that reduce the capability of a network to meet the QoS requirements of a QoS flow may degrade the performance of such applications.

### SUMMARY

This summary is a simplified summation of one or more aspects presented to provide a basic understanding of such aspects. This summary is not an extensive overview of all aspects contemplated, is not intended to identify key or critical elements of all aspects, and is not meant to delineate the scope of any or all aspects. This summary's sole purpose is to present some aspects in a simplified form as a prelude to the more detailed description that is presented later.

Various aspects may include a method performed by a first communication network elements, such as at an application function (AF). The method may include providing, such as to a core network (CN) element, Alternative Service Requirements for Protocol Data Unit (PDU) Sets supporting data traffic of an application, in which the Alternative Service Requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt.

An AF is described. The AF may include a memory and a processor, the memory and the processor configured to transmit, to a CN element, Alternative Service Requirements for Protocol Data Unit (PDU) Sets supporting data traffic of an application, in which the Alternative Service Requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt.

In some examples of the method, apparatuses, and non-transitory processor readable storage medium described herein, different Alternative Service Requirements for PDU Sets may include different combinations of PSDB, PSER, and GFBR values to which the application can adapt.

In some examples of the method, apparatuses, and non-transitory processor readable storage medium described herein, the different combinations of PSDB, PSER, and GFBR values may be in a prioritized order in each of the Alternative Service Requirements.

In some examples of the method, apparatuses, and non-transitory processor readable storage medium described herein, the QoS reference parameters may include a bit rate, a delay budget, and an error rate applicable to PDU Sets.

Some examples of the method, apparatuses, and non-transitory processor readable storage medium described herein may include operations, features, means, or instructions for receiving from the CN element an indication that a communication link between a Radio Access Network (RAN) element and a user equipment (UE) no longer supports or can no longer guarantee the GFBR for a QoS Flow transporting PDU Sets (i.e., a PDU Set capable QoS flow), in which the indication includes an identification of one of the QoS reference parameters corresponding to one of a plurality of Alternative QoS Parameters Sets, determining PSDB, PSER, and GFBR values for PDU Sets based on the identified QoS reference parameter, and updating codec settings for the PDU Set based traffic based on the determined PSDB, PSER, and GFBR values.

Various aspects may include a method performed at a first core network (CN) element. The method may include receiving, from an Application Function (AF), Alternative Service Requirements for Protocol Data Unit (PDU) Sets supporting data traffic of an application, in which each of the Alternative Service Requirements for PDU Sets include one or more QoS reference parameters and a combination of a PDU Set Delay Budget (PSDB) value, a PDU Set Error Rate (PSER) value, and a Guaranteed Flow Bit Rate (GFBR) value to which the application can adapt, transmitting to a second CN element Policy and Charging Control (PCC) rules based on a plurality of Alternative QoS parameter sets derived from the one or more QoS reference parameters of the Alternative Service Requirements for PDU Sets, receiving from said second CN element an indication that a communication link between a Radio Access Network (RAN) element and a user equipment (UE) no longer supports or can no longer guarantee a current GFBR for a QoS Flow transporting PDU Sets, wherein the indication includes a reference to one of a plurality of Alternative QoS Profiles (AQPs) that identifies a PSDB value, a PSER value, and a GFBR value to which the application can adapt, and transmitting to the AF a notification that the communication link between the RAN element and the UE no longer supports or can no longer guarantee the GFBR for the QoS Flow transporting PDU Sets (i.e., a PDU Set capable QoS flow), in which the notification includes an identification of one of the QoS reference parameters of the Alternative Service Requirements for PDU Sets that can be supported.

A first core network (CN) element is described. The first CN element may include a memory and a processor, the processor configured to receive, from an Application Function (AF), Alternative Service Requirements for Protocol Data Unit (PDU) Sets supporting data traffic of an application, in which each of the Alternative Service Requirements for PDU Sets include one or more QoS reference parameters and a combination of a PDU Set Delay Budget (PSDB) value, a PDU Set Error Rate (PSER) value, and a Guaranteed Flow Bit Rate (GFBR) value to which the application can adapt, transmit to a second CN element Policy and Charging Control (PCC) rules based on a plurality of Alternative QoS parameter sets derived from the one or more QoS reference parameters of the Alternative Service Requirements for PDU Sets, receive from said CN element an indication that a communication link between a Radio Access Network (RAN) element and a user equipment (UE) no longer supports or can no longer guarantee a current GFBR for a QoS Flow transporting PDU Sets (i.e., a PDU Set capable QoS flow), in which the indication includes a reference to one of a plurality of Alternative QoS Profiles (AQPs) that identifies a PSDB value, a PSER value, and a GFBR value to which the application can adapt, and transmit to the AF a notification that the communication link between the RAN element and the UE no longer supports or can no longer guarantee the GFBR for the QoS Flow transporting PDU Sets, in which the notification includes an identification of one of the QoS reference parameters of the Alternative Service Requirements for PDU Sets that can be supported.

In some examples of the method, apparatuses, and non-transitory processor readable storage medium described herein, the first CN entity may be a Policy Control Function (PCF), the second CN entity is a Session Management Function (SMF).

In some examples of the method, apparatuses, and non-transitory processor readable storage medium described herein, the first CN entity and the second CN entity may be the same entities or co-located entities.

Various aspects may include a method performed at a first core network (CN) element. The method may include receiving, from a second CN element, Policy and Charging Control (PCC) rules for data traffic supporting an application that is based on QoS requirements for PDU Sets and a plurality of Alternative QoS parameter sets including a PDU Set Delay Budget (PSDB) value and a PDU Set Error Rate (PSER) value, establishing a QoS Flow transporting PDU Sets (i.e., a PDU Set capable QoS flow) for data traffic supporting the application with a Radio Access Network (RAN) element, including transmitting to the RAN element a QoS profile for the QoS Flow transporting PDU Sets and one of a plurality of Alternative QoS Profiles (AQP) derived from the plurality of Alternative QoS parameter sets, receiving from the RAN element an indication that a communication link with a user equipment (UE) no longer supports or can no longer guarantee a Guaranteed Flow Bit Rate (GFBR) for the QoS Flow transporting PDU Sets, in which the indication includes a reference to one of the plurality of AQPs that identifies a PDU Set Delay Budget (PSDB) value, a PDU Set Error Rate (PSER) value, and a GFBR value that the RAN element can support and to which the application can adapt, and transmitting to the second CN element a notification that the communication link with the UE no longer supports or can no longer guarantee the GFBR for the QoS Flow transporting PDU Sets (i.e., a PDU Set capable QoS flow), in which the notification includes a reference to one of the Alternative QoS parameter sets associated with the AQP that the RAN element can support.

A first core network (CN) element is described. The first CN element may include a memory and a processor, the processor configured to receive, from a second CN element, Policy and Charging Control (PCC) rules for data traffic supporting an application that is based on QoS requirements for PDU Sets and a plurality of Alternative QoS parameter sets including a PDU Set Delay Budget (PSDB) value and a PDU Set Error Rate (PSER) value, establish a QoS Flow transporting PDU Sets for data traffic supporting the application with a Radio Access Network (RAN) element, including transmitting to the RAN element a QoS profile for the QoS Flow transporting PDU Sets (i.e., a PDU Set capable QoS flow) and one of a plurality of Alternative QoS Profiles (AQPs) derived from the plurality of Alternative QoS parameter sets, receive from the RAN element an indication that a communication link with a user equipment (UE) no longer supports or can no longer guarantee a Guaranteed Flow Bit Rate (GFBR) for the QoS Flow transporting PDU Sets (i.e., a PDU Set capable QoS flow), in which the indication includes a reference to one of the plurality of AQPs that identifies a PDU Set Delay Budget (PSDB) value, a PDU Set Error Rate (PSER) value, and a GFBR value that the RAN element can support and to which the application can adapt, and transmit to the second CN element a notification that the communication link with the UE no longer supports or can no longer guarantee the GFBR for the QoS Flow transporting PDU Sets (i.e., a PDU Set capable QoS flow), in which the notification includes a reference to one of the Alternative QoS parameter sets associated with the AQP that the RAN element can support.

Some examples of the method, apparatuses, and non-transitory processor readable storage medium described herein may include receiving from the RAN element an indication that the communication link with the UE again supports or can guarantee the GFBR for the QoS Flow transporting PDU Sets (i.e., a PDU Set capable QoS flow), and transmitting to the second CN element a notification that the communication link with the UE can guarantee again the GFBR for the QoS Flow transporting PDU Sets.

In some examples of the method, apparatuses, and non-transitory processor readable storage medium described herein, the first CN entity may include a Session Management Function (SMF) and the second CN entity may include a Policy Control Function (PCF).

In some examples of the method, apparatuses, and non-transitory processor readable storage medium described herein, the first CN entity and the second CN entity may be the same entities or co-located entities.

Various aspects may include a method performed at a Radio Access Network (RAN) element. The method may include receiving, from a core network (CN) element Alternative quality of service (QoS) Profiles (AQPs) for Protocol Data Unit (PDU) Sets, determining that a communication link with a user equipment (UE) no longer supports or can no longer guarantee a quality of service (QoS) profile for a current QoS Flow transporting PDU Sets (i.e., a PDU Set capable QoS flow), determining that at least one of the AQPs for PDU Sets can be supported by checking whether a Guaranteed Flow Bit Rate (GFBR) value, PDU Set Delay Budget (PSDB) value, and a PDU Set Error Rate (PSER) value can be supported by the RAN element, and transmitting to the CN element an indication that the communication link with the UE no longer supports or can no longer guarantee the QoS profile for the current QoS Flow transporting PDU Sets, in which the indication includes a reference parameter for one of a plurality of AQPs that includes a PSDB value, a PSER value, and a GFBR value to which the application can add adapt.

A Radio Access Network (RAN) element is described. The RAN element may include a memory and a processor, the processor configured to receive, from a core network (CN) element Alternative quality of service (QoS) Profiles (AQPs) for Protocol Data Unit (PDU) Sets, determine that a communication link with a user equipment (UE) no longer supports or can no longer guarantee a quality of service (QoS) profile for a current QoS Flow transporting PDU Sets (i.e., a PDU Set capable QoS flow), determine that at least one of the AQPs for PDU Sets can be supported by checking whether a Guaranteed Flow Bit Rate (GFBR) value, PDU Set Delay Budget (PSDB) value, and a PDU Set Error Rate (PSER) value can be supported by the RAN element, and transmit to the CN element an indication that the communication link with the UE no longer supports or can no longer guarantee the QoS profile for the current QoS Flow transporting PDU Sets, in which the indication includes a reference parameter for one of a plurality of AQPs that includes a PSDB value, a PSER value, and a GFBR value to which the application can add adapt.

Some examples of the method, apparatuses, and non-transitory processor readable storage medium described herein may include determining that the communication link with the UE again supports or can guarantee the QoS profile for the QoS Flow transporting PDU Sets, and transmitting to the CN element an indication that the communication link with the UE again supports or can guarantee the QoS profile for the QoS Flow transporting PDU Sets.

Some aspects may include an apparatus for wireless communication at a first network element, which may include one or more memories, and one or more processors coupled to the one or more memories and configured to cause the first network element to provide to a second network element Alternative Service Requirements for PDU Sets supporting data traffic of an application, in which the Alternative Service Requirements for PDU Sets include one or more QoS reference parameters and a combination of a PSDB value, a PSER value, and a GFBR value to which the application can adapt. In some aspects, the one or more processors may be further configured to cause the first network element to adapt one or more parameters for PDU Set based traffic based on information received from the second network element that the second network element will send if the second network element cannot support a default QoS. In some aspects, different ones of the Alternative Service Requirements for PDU Sets include different combinations of PSDB, PSER, and GFBR values to which the application can adapt. In some aspects, the different combinations of PSDB, PSER, and GFBR values may be in a prioritized order in each of the Alternative Service Requirements.

In some aspects, to adapt one or more parameters for PDU Set based traffic based on information received in response from the second network element, the one or more processors may be further configured to cause the first network element to: receive from the second network element an indication that a communication link between a third network element and a UE can no longer guarantee the GFBR for the QoS Flow transporting PDU Sets, wherein the indication includes an identification of one of the QoS reference parameters corresponding to one of a plurality of Alternative QoS Parameters Sets; determine PSDB, PSER, and GFBR values for PDU Sets based on the identified QoS reference parameter; and update codec settings for PDU Set based traffic based on the determined PSDB, PSER, and GFBR values. In some aspects, the second network element may be a core network element; and the indication that a communication link between a third network element and a UE can no longer guarantee the GFBR for the QoS Flow transporting PDU Sets may be received from the core network element as an indication that the communication link between a Radio Access Network (RAN) and the UE longer supports the GFBR for the QoS Flow transporting PDU Sets.

Some aspects may include an apparatus for wireless communication at a first network element, which may include one or more memories, and one or more processors coupled to the one or more memories and configured to cause the first network element to: obtain a QoS profile for a QoS Flow transporting PDU Sets and one of a plurality of Alternative Service Requirements for PDU Sets supporting data traffic of an application, wherein each of the Alternative Service Requirements for PDU Sets include one or more QoS reference parameters and a combination of a PSDB value, a PSER value, and a GFBR value to which the application can adapt; provide Policy and Charging Control (PCC) rules based on a plurality of Alternative QoS parameter sets derived from the one or more QoS reference parameters of the Alternative Service Requirements for PDU Sets; receive an indication that a communication link between a second network element and a UE can no longer guarantee a current GFBR for a QoS Flow transporting PDU Sets, wherein the indication includes a reference to one of a plurality of Alternative QoS Profiles that identifies a PSDB value, a PSER value, and a GFBR value to which the application can adapt; and provide a notification that the communication link between the second element and the UE can no longer guarantee the GFBR for the QoS Flow transporting PDU Sets, wherein the notification includes an identification of one of the QoS reference parameters of the Alternative Service Requirements for PDU Sets that can be supported. In some aspects, the one or more processors may be further configured to cause the first network element to determine that the communication link with the UE can guarantee the QoS profile for the QoS Flow transporting PDU Sets, and provide an indication that the communication link with the UE can guarantee the QoS profile for the QoS Flow transporting PDU Sets. In some aspects, the first network element may include a Policy Control Function (PCF) network element; the Alternative Service Requirements for PDU Sets supporting data traffic of the application may be obtained from an Application Function (AF) network element; the PCC rules may be provided to a SMF network element; the indication that a communication link between a second network element and a UE can no longer guarantee a current GFBR for a QoS Flow transporting PDU Sets may be received from the SMF network element; and the notification that the communication link between the second element and the UE can no longer guarantee the GFBR for the QoS Flow transporting PDU Sets may be provided to the AF network element.

Some aspects may include an apparatus for wireless communication at a first network element, which may include one or more memories and one or more processors coupled to the one or more memories and configured to cause the first network element to: obtain PCC rules for data traffic supporting an application that may be based on QoS requirements for PDU Sets and a plurality of Alternative QoS parameter sets including a PSDB value and a PSER value; establish a QoS Flow for transporting PDU Sets for data traffic supporting the application with a second network element, wherein to establish the QoS flow, the one or more processor may be configured to cause the first network element to provide to the second network element a QoS profile for the QoS Flow transporting PDU Sets and one of a plurality of Alternative QoS Profiles derived from the plurality of Alternative QoS parameter sets; receive from the second network element an indication that a communication link with a UE can no longer guarantee a GFBR for the QoS Flow transporting PDU Sets, wherein the indication includes a reference to one of the plurality of Alternative QoS Profiles that identifies a PSDB value, a PSER value, and a GFBR value that the second network element can support and to which the application can adapt; and provide a notification that the communication link with the UE can no longer guarantee the GFBR for the QoS Flow transporting PDU Sets, wherein the notification includes a reference to one of the Alternative QoS parameter sets associated with the AQP that the second network element can support. In some aspects, different ones of the plurality of Alternative QoS Profiles for PDU Sets include different combinations of PSDB, PSER, and GFBR. In some aspects, different ones of the plurality of Alternative QoS Profiles for PDU Sets include different combinations of PSDB, PSER, GFBR, and a maximum data burst volume (MDBV). In some aspects, the one or more processors may be further configured to cause the first network element to: receive from the second network element an indication that the communication link with the UE can guarantee the GFBR for PDU Sets session for application data traffic being communicated between the second network element and the UE; and provide a notification that the communication link with the UE can guarantee the GFBR for the QoS Flow transporting PDU Sets in a PDU session for application data traffic being communicated between the second element and the UE. In some aspects, the first network element may be a SMF network element, PCC rules for data traffic supporting the application may be received from a PCF network element, the second network element may be a Radio Access Network element, the notification that the communication link with the UE can no longer guarantee the GFBR for the QoS Flow transporting PDU Sets may be transmitted to the PCF network element, and the notification that the communication link with the UE can guarantee the GFBR for the QoS Flow transporting PDU Sets in a PDU session for application data traffic being communicated between the second element and the UE may be transmitted to the PCF network element.

Some aspects may include an apparatus for wireless communication at a first network element, which may include one or more memories; and one or more processors coupled to the one or more memories and configured to cause the first network element to: obtain from a second network element Alternative QoS Profiles for PDU Sets; determine that a communication link with a UE can no longer guarantee a QoS profile for a current QoS Flow transporting PDU Sets; determine that at least one of the Alternative QoS Profiles for PDU Sets can be supported by checking whether a GFBR value, PSDB value, and a PSER value can be supported by the first network element; and provide to the second network element an indication that the communication link with the UE can no longer guarantee the QoS profile for the current QoS Flow transporting PDU Sets, wherein the indication includes a reference parameter for one of a plurality of Alternative QoS Profiles that includes a PSDB value, a PSER value, and a GFBR value to which an application can add adapt. In some aspects, different ones of the Alternative QoS Profiles for PDU Sets include different combinations of PSDB, PSER, and GFBR. In some aspects, different ones of the Alternative QoS Profiles for PDU Sets include different combinations of PSDB, PSER, GFBR, and a maximum data burst volume (MDBV). In some aspects, the one or more processors may be further configured to cause the first network element to: determine that the communication link with the UE can guarantee the QoS profile for the QoS Flow transporting PDU Sets; and provide to the second network element an indication that the communication link with the UE can guarantee the QoS profile for the QoS Flow transporting PDU Sets. In some aspects, the first network element may be a Radio Access Network, and the second network element may be a core network element.

Some aspects may include an apparatus for wireless communication at a first network element, which may include one or more memories, and one or more processors couple to the memory and configured to cause the first network element to: receive an indication of a change in a bit rate or frame rate of a data flow between a second network element and a UE; establish one or more QoS parameters with a third network element to support the change in a bit rate or frame rate of the data flow in response to receiving the indication; and provide to the UE a configuration message that configures one or more UE communication parameters to implement the established QoS parameters. In some aspects, to establish QoS parameters with the third network element, the one or more processors may be further configured to receive from the third network element a reference parameter of one of a plurality of Alternative QoS Profiles that were previously established with the third network element for a PDU set supporting the data flow. In some aspects, the one or more processors may be further configured to establish the plurality of Alternative QoS Profiles with the third network element as part of establishing the data flow to the UE, wherein each of the Alternative QoS Profiles may be associated with a reference parameter and supports a particular bit rate or frame rate for a communication link between the first network element and the UE suitable for supporting the data flow. In some aspects, the one or more processors may be further configured to provide to the third network element a request for a reestablishment or update of the QoS parameters.

Some aspects may include an apparatus for wireless communication at a first network element, which may include one or more memories, and one or more processors coupled to the one or more memories and configured to cause the first network element to: obtain an indication of a change in a bit rate or frame rate of a data flow; and establish one or more QoS parameters with a second network element to implement the change in the bit rate or frame rate. In some aspects, the one or more processors may be further configured to establish QoS parameters with the second network element by providing to the second network element a reference parameter of one of a plurality of Alternative QoS Profiles that were previously established with the second network element for a PDU set supporting the data flow. In some aspects, the one or more processors may be further configured to establish the plurality of Alternative QoS Profiles with the second network element as part of establishing the data flow to a UE, wherein each of the Alternative QoS Profiles may be associated with an identifier and supports a particular bit rate or frame rate for a communication link between the second network element and the UE supporting the data flow. In some aspects, the one or more processors may be further configured to cause the first network element to: receive from the second network element a request for a reestablishment or update of the QoS parameters; and adjust the bit rate or frame rate for the data flow related to the request for reestablishment or update of the QoS parameters.

### BRIEF DESCRIPTION OF THE DRAWINGS

FIG. 1A is a system block diagram illustrating an example communications system suitable for implementing any of the various aspects.

FIG. 1B is a system block diagram illustrating an example disaggregated base station architecture suitable for implementing any of the various aspects.

FIG. 1C is a system block diagram illustrating an example communications system suitable for implementing any of the various aspects.

FIG. 2 is a component block diagram illustrating an example computing and wireless modem system suitable for implementing any of the various aspects.

FIG. 3 is a component block diagram illustrating a software architecture including a radio protocol stack for the user and control planes in wireless communications suitable for implementing any of the various aspects.

FIG. 4A is a block diagram illustrating an apparatus for wireless communication (e.g., an AF) that supports QoS management for PDU Sets according to various aspects.

FIG. 4B is a block diagram illustrating an apparatus for wireless communication (e.g., a CN element) that supports QoS management for PDU Sets according to various aspects.

FIG. 4C is a block diagram illustrating an apparatus for wireless communication (e.g., a CN element) that supports QoS management for PDU Sets according to various aspects.

FIG. 4D is a block diagram illustrating an apparatus for wireless communication (e.g., a RAN element) that supports QoS management for PDU Sets according to various aspects.

FIG. 5A is a message flow diagram illustrating operations of QoS flow set up and notification control according to various aspects.

FIG. 5A is a message flow diagram illustrating operations of QoS flow set up and notification control according to various aspects.

FIGS. 5C and 5D are tables illustrating example Alternative QoS Parameters and Alternative QoS Parameter Sets configured for use with PDU Sets according to various aspects.

FIG. 6 is a process flow diagram illustrating a method for QoS management for PDU Sets according to various implementations and aspects.

FIG. 7 is a process flow diagram illustrating a method for QoS management for PDU Sets according to various implementations and aspects.

FIG. 8A is a process flow diagram illustrating a method for QoS management for PDU Sets according to various implementations and aspects.

FIG. 8B is a process flow diagram illustrating operations that may be performed as part of the for QoS management for PDU Sets according to various implementations and aspects.

FIG. 9A is a process flow diagram illustrating a method for QoS management for PDU Sets according to various implementations and aspects.

FIG. 9B is a process flow diagram illustrating operations that may be performed as part of the method for QoS management for PDU Sets according to various implementations and aspects.

FIG. 10A is a block diagram illustrating a UE that supports wireless communications according to various aspects.

FIG. 10B is a block diagram illustrating a RAN element that supports wireless communications according to various aspects.

FIG. 10C is a block diagram illustrating an element of a CN element that supports wireless communications according to various aspects.

FIG. 11A is a process flow diagram illustrating a method for managing a broadcast signal according to various aspects.

FIG. 11B is a process flow diagram illustrating operations that may be performed as part of the for coordinating rate adaptation according to various aspects.

FIG. 12A is a process flow diagram illustrating a method for coordinating rate adaptation according to various aspects.

FIGS. 12B and 12C are process flow diagrams illustrating operations that may be performed as part of the for coordinating rate adaptation according to various implementations and aspects.

FIG. 13A is a process flow diagram illustrating a method for coordinating rate adaptation according to various aspects.

FIGS. 13B-13E are process flow diagrams illustrating operations that may be performed as part of the for coordinating rate adaptation according to various aspects.

FIG. 14 is a component block diagram of a UE suitable for use with various aspects.

FIG. 15 is a component block diagram of a network device suitable for use with various aspects.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

In certain 5G communication networks, when an established data communication flow to an application executing on a user equipment (UE) becomes unavailable, data communicating to/from the application may be interrupted while the network establishes a new connection. According to one more aspects, alternative parameter sets (referred to as “Alternative QoS Profiles”) for sending data to the application may be provided that the communication network can use if a current data flow is no longer available. The availability of Alternative QoS Profiles enables the communication network to switch to another communication data flow rather than perform time-consuming operations to renegotiate QoS requirements for a new data flow. The alternative parameter sets may be provided for sets of packet data units (PDUs) that carry data to the application. One or more aspects include the signaling among various network elements involved in identifying the alternative parameter sets and changing parameter sets to support a change in a communication flow when a switch in the data flow is required.

According to one or more other aspects, operations may be implemented in one or more network elements for communicating when there is a change in the bit rate or frame rate on an application executing on the UE, establishing new QoS parameters that will support a new bit rate or frame rate, and configuring communication parameters to implement the new QoS parameters. These operations enable switching to QoS parameters in a communication link to support the new bit rate or frame rate of the application without the delay of renegotiating QoS requirements.

Some applications that are executed on a network computing device (such as an application server), and corresponding applications that are executed on UE, such as an application client (AC), may transmit and receive large amounts of information, such as large amounts of audio, video, or multimedia information, that cannot be conveyed in a single PDU. For example, extended reality (XR) applications (e.g., virtual reality (VR) applications, augmented reality (AR) applications, mixed reality (MX) applications, and other similar applications) may generate large amounts of audio, video, or multimedia information, units of which (e.g., frames) are too large to be conveyed in a single PDU. To convey (transmit, transport) the data generated by such applications, PDU Sets are more appropriate.

A “PDU Set” is composed of one or more PDUs carrying the payload of one unit of information generated at the application level (e.g., a frame or video slice for XR media services, for example, as may be used in certain standards and technical reports, such as 3rd Generation Partnership Project (3GPP) Technical Report (TR) 26.926 [27]). In some implementations, an application must receive all of the PDUs in a PDU Set to use the information in the payload conveyed by the PDU Set. In some implementations, the application may recover parts or all of an information unit when some PDUs are not received.

Applications that send and receive large amounts information may be sensitive to QoS requirements. Variations in network conditions that reduce the capability of a network to meet the QoS requirements of a QoS flow may degrade the performance of such applications. To enable applications to more rapidly adapt to variations in network conditions, some applications may utilize Alternative QoS Profiles or Alternative Service Requirements. An Alternative QoS Profile or Alternative Service Requirement represents a combination of QoS parameters including packet delay budget (PDB), packet error rate (PER), guaranteed flow bit rate (GFBR), and, in certain cases, maximum data burst volume (MDBV) to which the application traffic is able to adapt. Additionally or alternatively, the Alternative QoS Profile or Alternative Service Requirement represents a combination of QoS parameters that the application executing on the UE can accept or adapt to. Additionally or alternatively, the Alternative QoS Profile or Alternative Service Requirements represents a combination of QoS parameters that may include a PDB to which the application is able to adapt, a PER to which the application is able to adapt, a GFBR to which the application is able to adapt, a MDBV to which the application is able to adapt, and combinations of these parameters. The availability of Alternative QoS Profiles or Alternative Service Requirement enables the communication network to rapidly switch to another QoS (i.e., one of the AQPs) rather than perform the time-consuming operations to renegotiate QoS requirements for a data flow. In various implementations, Alternative QoS Profile(s) may be provided for a GFBR QoS Flow with Notification control enabled. However, the conventional AQP feature is applicable only to PDU-based QoS flows. There is currently no mechanism to enable the use of Alternative QoS Profiles with PDU Set-based QoS flows

Various apparatuses for wireless communication configured to perform operations of various aspects described herein may include a network element configured to function as an application function (AF), one or more network elements configured to function as core network (CN) elements, and a network element configured to function as a RAN element. These various apparatuses may be configured to perform operations to utilize Alternative Service Requirements or Alternative QoS Profiles (AQPs) with PDU Sets, enabling various network elements to rapidly adapt to changes and variations in network conditions that reduce the capability of a network to meet QoS requirements of an application supported by data traffic using PDU sets. In various aspects, one or more network elements may be configured with Alternative QoS parameter sets that include QoS parameters configured for use with PDU Sets. In some aspects, alternative QoS parameters configured for use with PDU Sets may include a PDU Set Delay Budget (PSDB), a PDU Set Error Rate (PSER), a Guaranteed Flow Bit Rate (GFBR), and/or a maximum data burst volume (MDBV). In various aspects, an Alternative QoS Profile or Alternative Service Requirement configured for use with PDU Sets may include QoS parameters PSDB, PSER, GFBR, and MDBV to which application traffic is able to adapt. In some aspects, alternative PDU Set QoS parameter set(s) may define alternative set(s) of QoS parameters for a service data flow that requires a PDU Set-capable QoS flow. In some implementations, an Alternative PDU Set QoS parameter set may include a PSER, PSDB, an uplink (UL) guaranteed bit rate QoS parameter, and a downlink (DL) guaranteed bit rate QoS parameter.

In some aspects, an apparatus for wireless communication may be a CN element (e.g., a Policy Control Function (PCF), a Session Management Function (SMF), or another similar element of the CN) may be configured to perform operations for QoS Flow binding configured for PDU Sets. In some aspects, a CN element (e.g., an SMF or another suitable CN element) may provide a reference to AQPs that include PDU Set-related information. For example, an SMF may be configured to provide a reference to a PCF to AQPs that include PDU Set-related information. In some aspects, a CN element (e.g., a PCF or another suitable CN element) may be configured to report to the AF a QoS Reference parameter or a Requested Alternative QoS Parameter Set that corresponds to an alternative QoS parameter set that is referenced by another CN element (e.g., by the SMF or another suitable CN element).

In some aspects, an apparatus for wireless communication may be an AF configured to provide Alternative Service Requirements in a prioritized order. In some implementations, the Alternative Service Requirements may include one or more QoS reference parameters in a prioritized order, or one or more Requested Alternative QoS Parameters Sets(s) in a prioritized order (e.g., a Requested 5GS Delay applicable to PDU Sets, a Requested Error Rate applicable to PDU Sets, and/or a Requested Guaranteed Flow Bitrate applicable to PDU Sets).

In various aspects an AF may transmit, to a PCF, Alternative Service Requirements for PDU Sets supporting data traffic of an application. In such aspects, Service Requirements for PDU Sets may include one or more QoS reference parameters and a combination of a PSDB value, a PSER value, and a GFBR value to which the application can adapt. In some aspects, different Alternative Service Requirements for PDU Sets may include different combinations of PSDB, PSER, and GFBR values to which the application can adapt. In some aspects, the different combinations of PSDB, PSER, and GFBR values may be configured or arranged in a prioritized order in each of the Alternative Service Requirements. In some aspects, the QoS reference parameters may include a bit rate, a delay budget, and an error rate applicable to the PDU Set.

In some aspects, the AF may receive from the PCF an indication that a communication link between a RAN element and a UE no longer supports and thus can no longer guarantee the GFBR for the PDU Set that is being communicated between the RAN element and the UE. In such aspects, the indication may include an identification of one of the QoS reference parameters corresponding to one of a plurality of Alternative QoS Parameters Sets. The AF may determine PSDB, PSER, and GFBR values for the PDU Set based on the identified QoS reference parameter. The AF may update codec settings for the PDU Set that is being communicated between the RAN element and the UE based on the determined PSDB, PSER, and GFBR values.

In various aspects, a CN element (e.g., a PCF or another suitable CN element) may receive from an AF Alternative Service Requirements for PDU Sets supporting data traffic of an application. In such aspects, each of the Alternative Service Requirements for PDU Sets may include one or more QoS reference parameters and a combination of a PSDB value, a PSER value, and a GFBR value to which the application can adapt. In some aspects, the CN element may transmit to a Session Management Function (SMF) Policy and Charging Control (PCC) rules based on a plurality of Alternative QoS parameter sets derived from the one or more QoS reference parameters of the Alternative Service Requirements for PDU Sets. In some aspects, the CN element may receive from the SMF an indication that a communication link between an apparatus for wireless communication configured as a Radio Access Network (RAN) element and a UE no longer support and thus can no longer guarantee a current GFBR for a PDU Set that is being communicating between the RAN element and the UE (e.g., a notification that “GFBR of the QoS flow no longer supports or can no longer be guaranteed”). In such aspects, the indication may include a reference to one of a plurality of Alternative QoS Profiles (AQPs) that identifies a PSDB value, a PSER value, and a GFBR value to which the application can adapt. In some aspects, the CN element may transmit to the AF a notification that the communication link between the RAN element and the UE no longer supports or can no longer guarantee the GFBR for the PDU Set that is being communicated between the RAN element and the UE, wherein the notification includes an identification of one of the QoS reference parameters of the Alternative Service Requirements for PDU Sets that can be supported.

In various aspects, a CN element (e.g., an SMF or another suitable CN element) may receive, from a Policy Control Function (PCF), Policy and Charging Control (PCC) rules for data traffic supporting an application that is based on QoS requirements for a PDU Set and a plurality of Alternative QoS parameter sets including a PDU Set Delay Budget (PSDB) value and a PDU Set Error Rate (PSER) value. In some aspects, the CN element may establish a QoS Flow transporting PDU Sets (i.e., a PDU set capable QoS flow for sending PDU sets) for data traffic supporting the application with a Radio Access Network (RAN) element for a PDU Set, including transmitting to the RAN element a QoS profile for the PDU Set and one of a plurality of Alternative QoS Profiles (AQPs) derived from the plurality of Alternative QoS parameter sets. In some aspects, the CN element may receive from the RAN element an indication that a communication link with a UE no longer supports and thus can no longer guarantee a Guaranteed Flow Bit Rate GFBR for the QoS Flow transporting PDU Sets (i.e., a PDU Set capable QoS flow) for application data traffic being communicated between the RAN element and the UE (e.g., a notification that “GFBR of the QoS flow no longer supports or can no longer be guaranteed”). In such aspects, the indication may include a reference to one of the plurality of AQPs that identifies a PDU Set Delay Budget (PSDB) value, a PDU Set Error Rate (PSER) value, and a GFBR value that the RAN element can support and to which the application can adapt. In some aspects, the CN element may transmit to the PCF a notification that the communication link with the UE no longer supports or can no longer guarantee the GFBR for the PDU Set, wherein the notification includes a reference to one of the Alternative QoS parameter sets associated with the AQP that the RAN element can support.

In some aspects, the CN element may receive from the RAN element an indication that the communication link with the UE again supports and thus can guarantee again the GFBR for the QoS Flow transporting PDU Sets (i.e., a PDU Set capable QoS flow) for application data traffic being communicated between the RAN element and the UE. In such aspects, the CN element may transmit to the PCF a notification that the communication link with the UE again supports and thus can guarantee again the GFBR for the QoS Flow transporting PDU Sets (i.e., a PDU Set capable QoS flow) for application data traffic being communicated between the RAN element and the UE.

In various aspects, a RAN element may receive from a CN element Alternative quality of service (QoS) Profiles (AQPs) for Protocol Data Unit (PDU) Sets. In some aspects, the RAN element may determine that a communication link with a user equipment (UE) no longer supports and thus can no longer guarantee a quality of service (QoS) profile for a current PDU Set that is being communicated between the RAN element and the UE. In some aspects, the RAN element may determine that at least one of the AQPs for PDU Sets can be supported by checking whether a GFBR value, PSDB value, and a PSER value can be supported by the RAN element. In some aspects, the RAN element may transmit to the CN element an indication that the communication link with the UE no longer supports or can no longer guarantee the QoS profile for the QoS flow of the current PDU Set that is being communicated between the RAN element and the UE (e.g., a notification that “GFBR of the QoS flow no longer supports or can no longer be guaranteed”). In such aspects, the indication may include a reference parameter for one of a plurality of AQPs that includes a PSDB value, a PSER value, and a GFBR value to which the application can add adapt. In some aspects, the RAN element may determine that the communication link with the UE again supports and thus can guarantee again the QoS profile for the PDU Set that is being communicated between the RAN element and the UE. In such aspects, the RAN element made transmit to the CN element an indication that the communication link with the UE again supports and thus can guarantee again the QoS profile for the PDU Set that is being communicated between the RAN element and the UE.

Various implementations improve network communication and wireless communication by enabling an AF, CN element(s), and a RAN element to perform operations to utilize AQPs with PDU Sets. Among other things, utilizing AQPs with PDU Sets enables various network elements to rapidly adapt to changes and variations in network conditions that reduce the capability of a network to meet QoS requirements of an application. In this manner, various implementations improve the efficiency of operations of network communication and wireless communication elements and systems.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, wireless router devices, medical devices and equipment, biometric sensors/devices, wearable devices including smart watches, smart clothing, smart glasses, smart wrist bands, smart jewelry (for example, smart rings and smart bracelets), entertainment devices (for example, wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for global system for mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

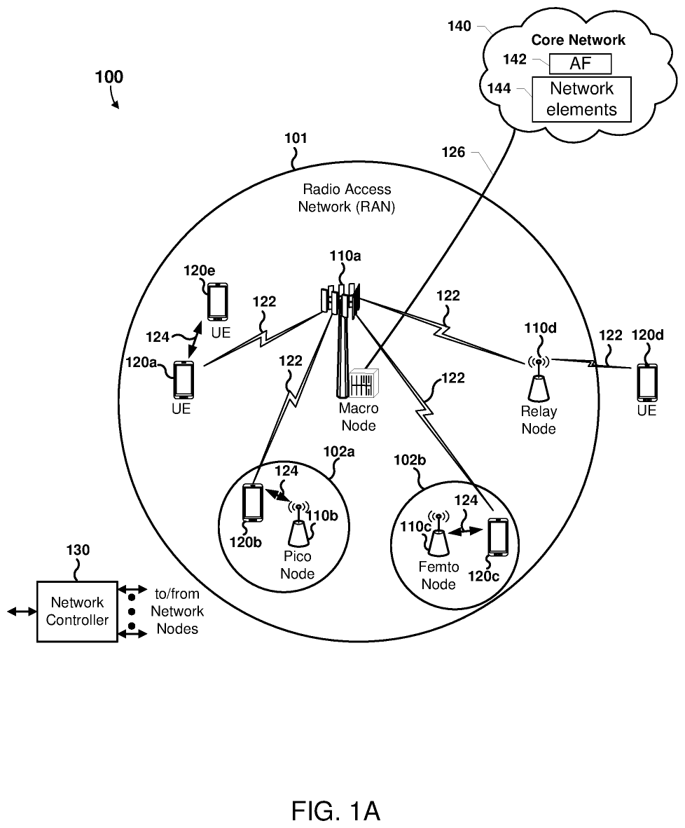

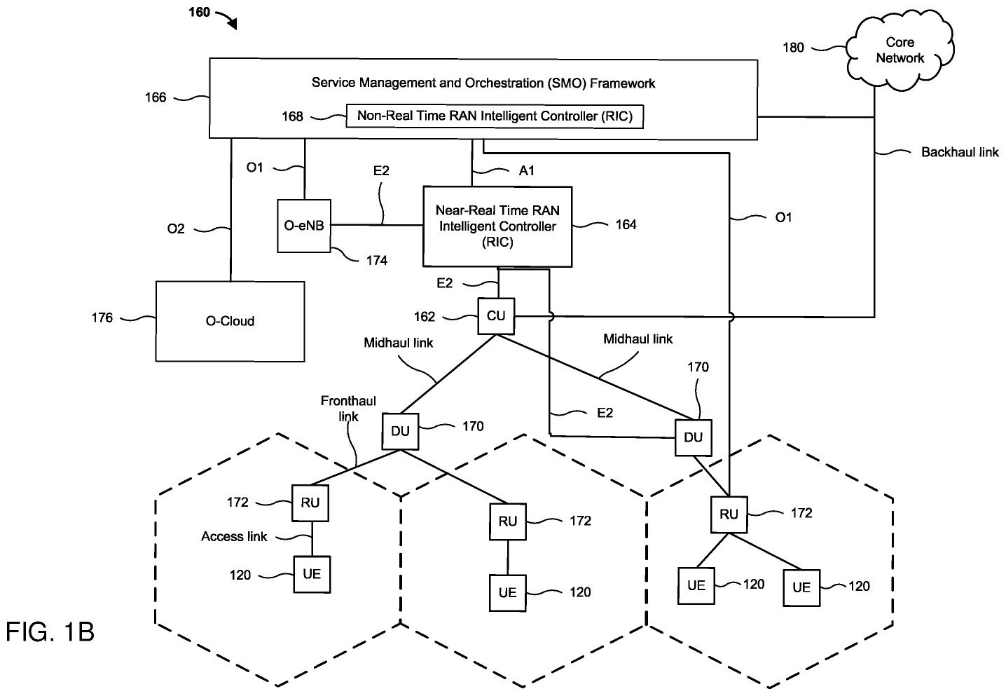

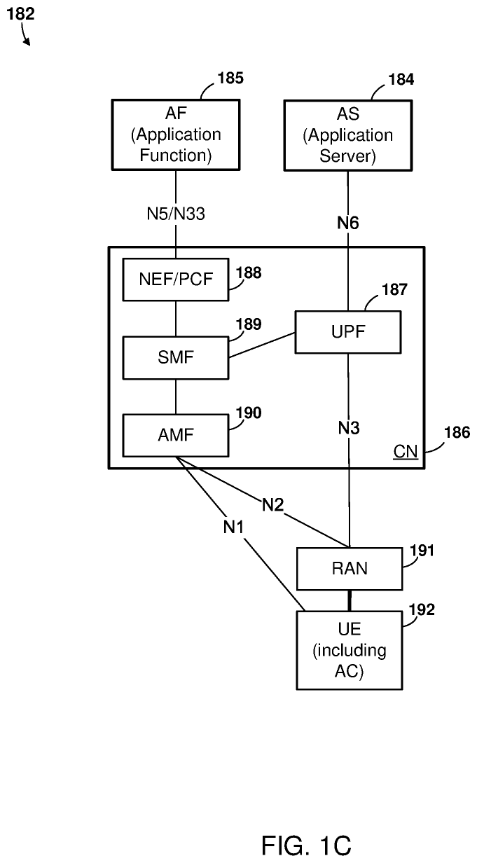

FIG. 1A is a system block diagram illustrating an example communications system 100 suitable for implementing any of the various aspects. The communications system 100 may be a 5G New Radio (NR) network, or any other suitable network such as a Long Term Evolution (LTE) network. While FIG. 1A illustrates a 5G network, later generation networks may include the same or similar elements. Therefore, the reference to a 5G network and 5G network elements in the following descriptions is for illustrative purposes and is not intended to be limiting.

The communications system 100 may include a heterogeneous network architecture that includes a radio access network (RAN) 101 coupled to a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various aspects may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network element) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc. The core network may include a network element functioning as an application function 142, as described further herein, and a number of core network elements 144, including one or more network elements providing a Session Management Function (SMF) and one or more network elements providing a Policy Control Function (PCF).

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node of the RAN 101, a network device 110b may be a pico node for a pico cell 102a, and a network device 110c may be a femto node for a femto cell 102b. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and transmit a transmission of the data to a downstream station (for example, a UE or a network device). A relay station also may be a UE that can relay transmissions for other UEs. In the example illustrated in FIG. 1A, a relay station 110d may communicate with macro the network device 110a and the UE 120d in order to facilitate communication between the network device 110a and the UE 120d. A relay station also may be referred to as a relay network device, a relay base station, a relay, etc.

The communications system 100 may be a heterogeneous network that includes network devices of different types, for example, macro network devices, pico network devices, femto network devices, relay network devices, etc. These different types of network devices may have different transmit power levels, different coverage areas, and different impacts on interference in communications system 100. For example, macro nodes may have a high transmit power level (for example, 5 to 40 Watts) whereas pico network devices, femto network devices, and relay network devices may have lower transmit power levels (for example, 0.1 to 2 Watts).

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122 and 124 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported.

Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network element, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various aspects. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via O1) or via creation of RAN management policies (such as A1 policies).

FIG. 1C is a system block diagram illustrating an example communications system 182 suitable for implementing any of the various aspects. With reference to FIGS. 1A-1C, the illustrated example computing system 182 may include an application server (AS) 184, an application function (AF) 185, a core network (CN) 186, a RAN 191, and a UE 192. The CN 186 may include functional elements such as User Plane Function (UPF) 187, Network Exposure Function (NEF)/Policy Control Function (PCF) 188, Session Management Function (SMF) 189, and Access and Mobility Management Function (AMF) 190.

The AS 194 may execute an application that transmits and/or receives a data flow. The AS 194 may communicate with the UPF 187 via an interface such as an N6 interface. The AF 185 may communicate with the NEF/PCF 188 via an interface such as an N5 or N33 interface.

The UPF 187 may perform operations including maintaining a PDU session, packet routing and forwarding, packet inspection, policy enforcement in the user plane, and QoS handling. The UPF 187 may communicate with the RAN 191 via an interface such as an N3 interface. The NEF aspect of the NEF/PCF 188 may perform operations to expose services and resources within and outside the CN 186. The PCF aspect of the NEF/PCF 188 may support a policy control framework, applies policies, may access subscription information, and perform other operations to govern network behavior. The SMF 189 may perform operations for session management, IP address allocation and management for the UE 192, user plane selection, QoS and policy enforcement in the control plane, and operations for service registration, discovery, and establishment. The AMF 190 may perform operations for mobility management, registration management, and connection management. The AMF 190 also may select an SMF 189 for managing a user session context for the UE 192. The AMF 190 may communicate with the RAN 191 via an interface such as an N2 interface, and with the UE 192 via an interface such as an N1 interface.

The RAN 191 may include one or more elements of a disaggregated base station architecture, aspects of which are illustrated in FIG. 1B. The UE 192 may include an application client (AC) that receives the data flow via the RAN 191 and/or transmits the data flow to the RAN 191 via a wireless communication link (e.g., 122).

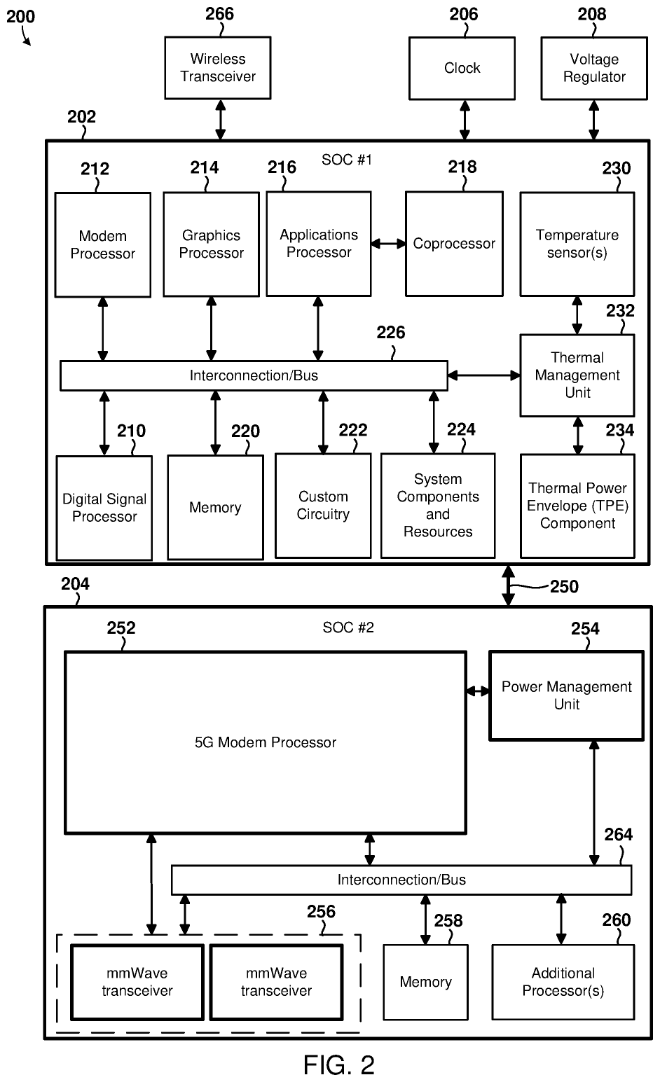

FIG. 2 is a component block diagram illustrating an example computing and wireless modem system 200 suitable for implementing any of the various aspects. Various aspects may be implemented on a number of single processor and multiprocessor computer systems, including a system-on-chip (SOC) or system in a package (SIP).

With reference to FIGS. 1A-2, the illustrated example computing system 200 (which may be a SIP in some aspects) includes a two SOCs 202, 204 that include one or more processors making up a processing system coupled to memory as described and to a clock 206, a voltage regulator 208, and a wireless transceiver 266 configured to send and receive wireless communications via an antenna (not shown) to/from a UE (e.g., 120a-120e) or a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the one or more processors, one or more memories 220, custom circuitry 222, system components and resources 224, an interconnection/bus module 226, one or more temperature sensors 230, a thermal management unit 232, and a thermal power envelope (TPE) component 234, which may be configured as a processing system. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the one or more processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the one or more processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the one or more processors 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

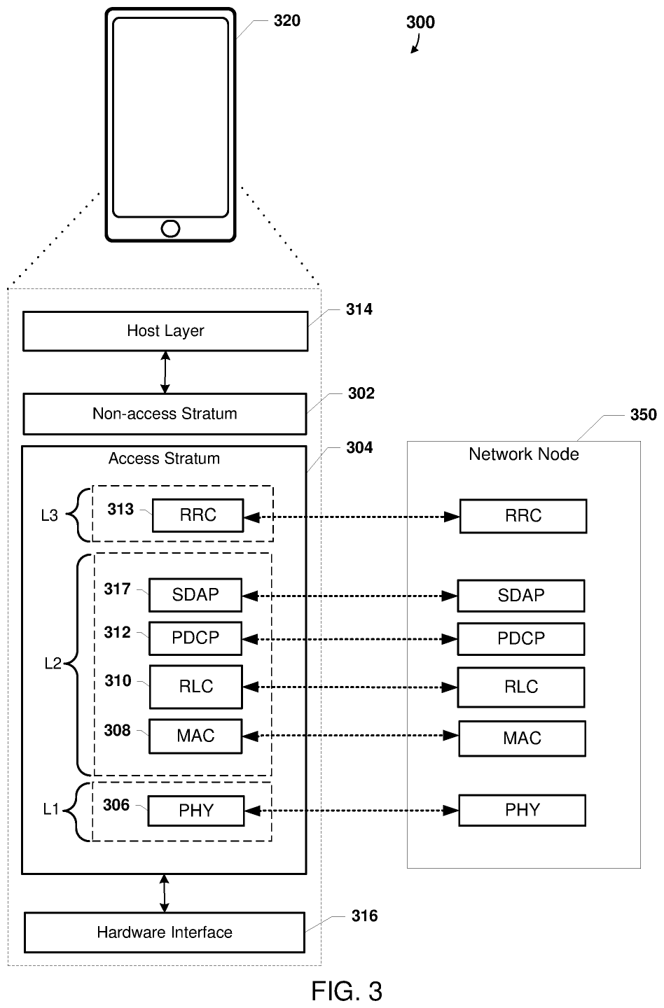

FIG. 3 is a component block diagram illustrating a software architecture 300 including a radio protocol stack for the user and control planes in wireless communications suitable for implementing any of the various aspects. With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various aspects, layers in software architecture 300 may form logical connections with corresponding layers in software of the network device 350. The software architecture 300 may be distributed among one or more processors (e.g., the one or more processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network node 350.

In various aspects, the SDAP sublayer 317 may provide mapping between Quality of Service (QoS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layer (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

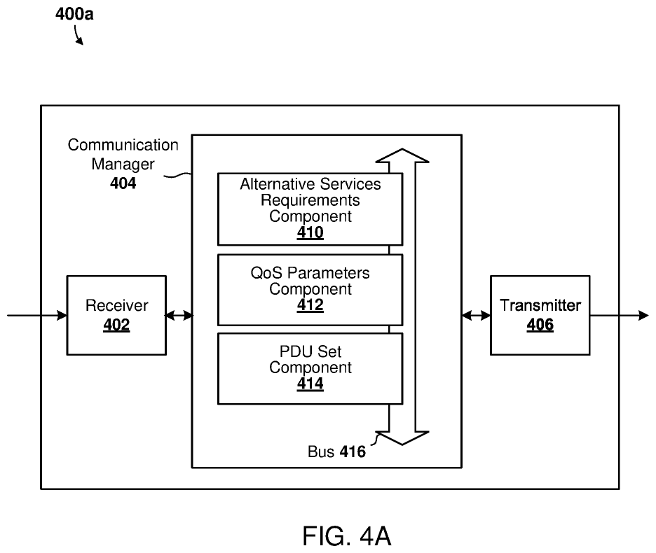

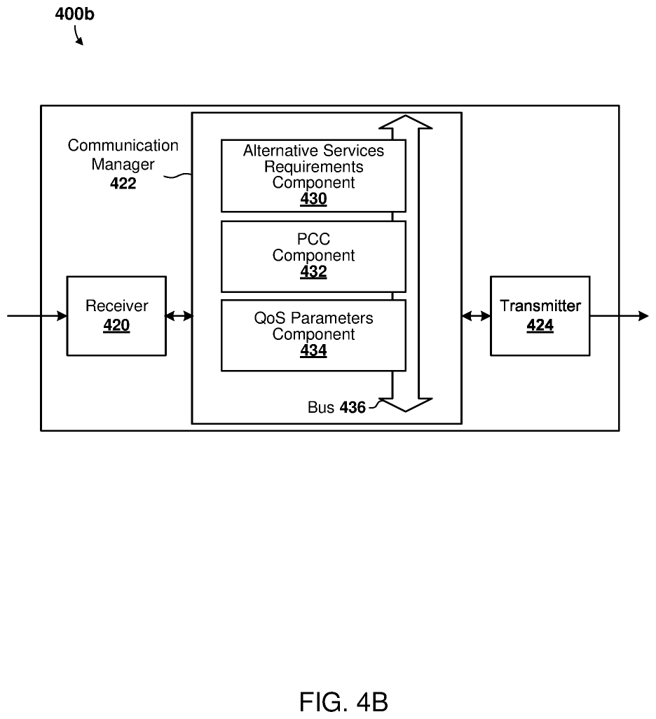

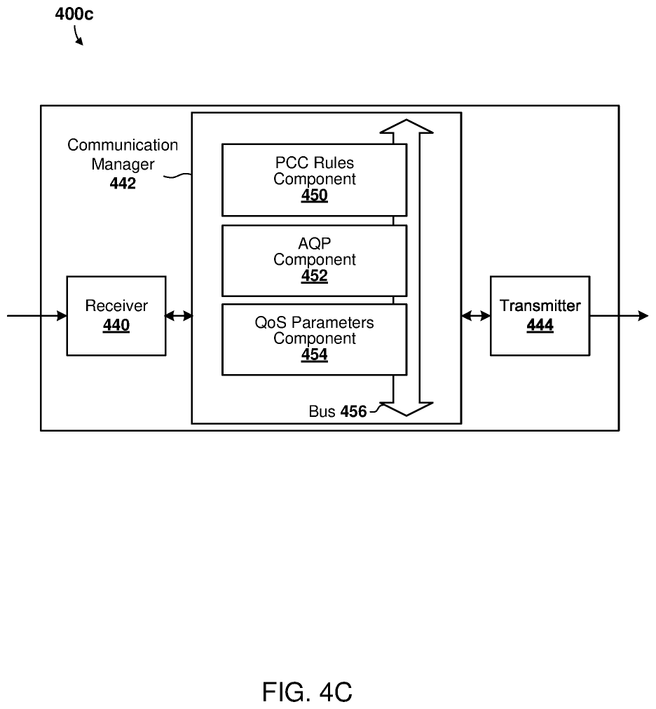

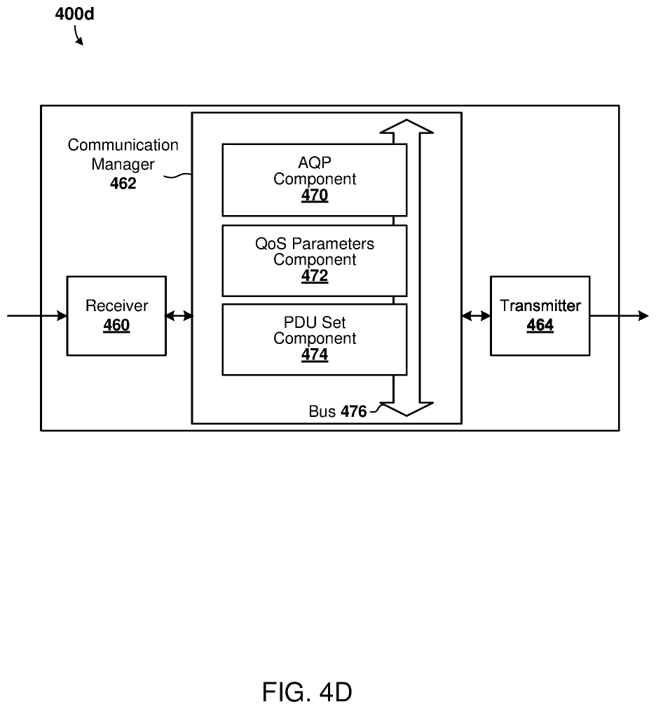

FIG. 4A is a block diagram illustrating an application function (AF) 400a that supports QoS management for PDU Sets according to various aspects. With reference to FIGS. 1A-4A, the AF 400a (e.g., 185) be configured to communicate with other CN elements (e.g., the PCF 188), an element of a RAN (e.g., 160, 191, 350) (i.e., a RAN element), and a UE (e.g., 120a-120e, 192, 200, 320). The AF 400a may be configured with a receiver 402, a communication manager 404, and a transmitter 406. The receiver 402 may receive information, such as packets, control information, etc., associated with network communications. The receiver 402 may be an example of aspects of a transceiver 256 or 266, and may be configured with wired or wireless communication components. The transmitter 406 may send information, such as packets, control information, etc., associated with RF communications. The transmitter 406 may be an example of aspects of a transceiver 256 or 266, and may be configured with wired or wireless communication components.

The communication manager 404 may be an example of aspects of processor 212, 214, 216, 218, 210, 252. The communication manager 404 may include an Alternative Services Requirements component 410, a QoS parameters component 412, and a PDU Set component 414, which may communicate over a communication bus 416 or another suitable communication element. The communication manager 404 may transmit, to a core network (CN) element, Alternative Service Requirements for Protocol Data Unit (PDU) Sets supporting data traffic of an application, in which the Alternative Service Requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt. In some aspects, different Alternative Service Requirements for PDU Sets include different combinations of PSDB, PSER, and GFBR values to which the application can adapt. In some aspects, the different combinations of PSDB, PSER, and GFBR values are in a prioritized order in each of the Alternative Service Requirements. In some aspects, the QoS reference parameters include a bit rate, a delay budget, and an error rate applicable to PDU Sets.

The communication manager 404 may receive from the CN element an indication that a communication link between a Radio Access Network (RAN) element and a user equipment (UE) no longer supports and thus can no longer guarantee the GFBR for the QoS Flow transporting PDU Sets (i.e., a PDU Set capable QoS flow), in which the indication includes an identification of one of the QoS reference parameters corresponding to one of a plurality of Alternative QoS Parameters Sets. The communication manager 404 may determine PSDB, PSER, and GFBR values for PDU Sets based on the identified QoS reference parameter. The communication manager 404 may update codec settings for PDU Set based traffic based on the determined PSDB, PSER, and GFBR values.

FIG. 4B is a block diagram illustrating a CN element 400b that supports QoS management for PDU Sets according to various aspects. With reference to FIGS. 1A-4B, the CN element 400b (e.g., PCF 188) may be configured to communicate with an AF (e.g., 185) and an SMF (e.g., 189) as well as other CN elements. The CN element 400b may be configured with a receiver 420, a communication manager 422, and a transmitter 424. The receiver 420 may receive information, such as packets, control information, etc., associated with network communications. The receiver 402 may be an example of aspects of a transceiver 256 or 266, which may include wired and wireless communication components. The transmitter 424 may send information, such as packets, control information, etc., associated with network communications. The transmitter 424 may be an example of aspects of a transceiver 256 or 266.

The communication manager 422 may be an example of aspects of processor 212, 214, 216, 218, 210, 252. The communication manager 422 may include an Alternative Services Requirements component 430, a PCC component 432, and a QoS parameters component 434, which may communicate over a communication bus 436 or another suitable communication element. The communication manager 422 may receive, from an Application Function (AF), Alternative Service Requirements for Protocol Data Unit (PDU) Sets supporting data traffic of an application, wherein each of the Alternative Service Requirements for PDU Sets include one or more QoS reference parameters and a combination of a PSDB value, a PSER value, and a GFBR value to which the application can adapt. The communication manager 422 may transmit to a second CN element (e.g., an SMF) Policy and Charging Control (PCC) rules based on a plurality of Alternative QoS parameter sets derived from the one or more QoS reference parameters of the Alternative Service Requirements for PDU Sets.

The communication manager 422 may receive from the second CN element an indication that a communication link between a Radio Access Network (RAN) element and a user equipment (UE) no longer supports and thus can no longer guarantee a current GFBR for a QoS Flow transporting PDU Sets (i.e., a PDU Set capable QoS flow), in which the indication includes a reference to one of a plurality of Alternative QoS Profiles (AQPs) that identifies a PSDB value, a PSER value, and a GFBR value to which the application can adapt. The communication manager 422 may transmit to the AF a notification that the communication link between the RAN element and the UE no longer supports and thus can no longer guarantee the GFBR for the QoS Flow transporting PDU Sets (i.e., a PDU Set capable QoS flow), wherein the notification includes an identification of one of the QoS reference parameters of the Alternative Service Requirements for PDU Sets that can be supported.

FIG. 4C is a block diagram illustrating a CN element 400c that supports QoS management for PDU Sets according to various aspects. With reference to FIGS. 1A-4C, the CN element 400c (e.g., SMF 189) may be configured to communicate with an NEF/PCF (e.g., 188), an AMF (e.g., 190), and a UPF (e.g., 187), as well as other CN elements. The CN element 400c may be configured with a receiver 440, a communication manager 442, and a transmitter 444. The receiver 440 may receive information, such as packets, control information, etc., associated with network communications. The receiver 440 may be an example of aspects of a transceiver 256 or 266, which may include wired and wireless communication components. The transmitter 444 may send information, such as packets, control information, etc., associated with network communications. The transmitter 444 may be an example of aspects of a transceiver 256 or 266, which may include wired and wireless communication components.

The communication manager 442 may be an example of aspects of processor 212, 214, 216, 218, 210, 252. The communication manager 442 may include a Policy and Charging Control (PCC) rules component 450, an AQP component 452, and a QoS parameters component 454, which may communicate over a communication bus 456 or another suitable communication element. The communication manager 442 may receive, from a second CN element (e.g., a PCF), Policy and Charging Control (PCC) rules for data traffic supporting an application that is based on QoS requirements for PDU Sets and a plurality of Alternative QoS parameter sets including a PDU Set Delay Budget (PSDB) value and a PDU Set Error Rate (PSER) value. The communication manager 442 may establish a QoS Flow transporting PDU Sets (i.e., a PDU Set capable QoS flow) for data traffic supporting the application with a Radio Access Network (RAN) element, including transmitting or otherwise providing to the RAN element a QoS profile for the QoS Flow transporting PDU Sets and one of a plurality of Alternative QoS Profiles (AQPs) derived from the plurality of Alternative QoS parameter sets.

The communication manager 442 may receive from the RAN element an indication that a communication link with a UE no longer supports and thus can no longer guarantee a GFBR for the QoS Flow transporting PDU Sets (i.e., a PDU Set capable QoS flow), wherein the indication includes a reference to one of the plurality of AQPs that identifies a PSDB value, a PSER value, and a GFBR value that the RAN element can support and to which the application can adapt. The communication manager 442 may transmit to the second CN element a notification that the communication link with the UE no longer supports and thus can no longer guarantee the GFBR for the QoS Flow transporting PDU Sets, wherein the notification includes a reference to one of the Alternative QoS parameter sets associated with the AQP that the RAN element can support. In some aspects, the communication manager 442 may receive from the RAN element an indication that the communication link with the UE again supports and thus can guarantee again the GFBR for the QoS Flow transporting PDU Sets (i.e., a PDU Set capable QoS flow). The communication manager 442 may transmit to the second CN element a notification that the communication link with the UE supports or can guarantee again the GFBR for the QoS Flow transporting PDU Sets.

FIG. 4D is a block diagram illustrating a RAN element 400d that supports QoS management for PDU Sets according to various aspects. With reference to FIGS. 1A-4D, the RAN element 400d (e.g., 110a-110d, 162, 170, 172, 174, 191, 200, 350) may be configured to communicate with a UE (e.g., UE 120a-120e, 192, 200, 320), an AMF (e.g., 190), and a UPF (e.g., 187), as well as other CN elements. The RAN element 400d may be configured with a receiver 460, a communication manager 462, and a transmitter 464. The receiver 460 may receive information, such as packets, control information, etc., associated with network communications. The receiver 460 may be an example of aspects of a transceiver 256 or 266, which may include wired and wireless communication components. The transmitter 464 may send information, such as packets, control information, etc., associated with network communications. The transmitter 464 may be an example of aspects of a transceiver 256 or 266, which may include wired and wireless communication components.

The communication manager 462 may be an example of aspects of processor 212, 214, 216, 218, 210, 252. The communication manager 462 may include an AQP component 470, a QoS parameters component 472, and a PDU Set component 474, which may communicate over a communication bus 476 or another suitable communication element. The communication manager 442 may receive from a core network (CN) element (e.g., an SMF) Alternative quality of service (QoS) Profiles (AQPs) for Protocol Data Unit (PDU) Sets. The communication manager 442 may determine that a communication link with a user equipment (UE) no longer supports and thus can no longer guarantee a quality of service (QoS) profile for a current QoS Flow transporting PDU Sets (i.e., a PDU Set capable QoS flow). The communication manager 442 may determine that at least one of the AQPs for PDU Sets can be supported by checking whether a Guaranteed Flow Bit Rate (GFBR) value, PDU Set Delay Budget (PSDB) value, and a PDU Set Error Rate (PSER) value can be supported by the RAN element. The communication manager 442 may transmit to the CN element an indication that the communication link with the UE no longer supports and thus can no longer guarantee the QoS profile for the current QoS Flow transporting PDU Sets, in which the indication includes a reference parameter for one of a plurality of AQPs that includes a PSDB value, a PSER value, and a GFBR value to which the application can add adapt.

In some aspects, the communication manager 442 may determine that the communication link with the UE again supports and thus can guarantee again the QoS profile for the PDU Set that is being communicated between the RAN element and the UE. The communication manager 442 may transmit to the CN element an indication that the communication link with the UE again supports and thus can guarantee again the QoS profile for the PDU Set that is being communicated between the RAN element and the UE.

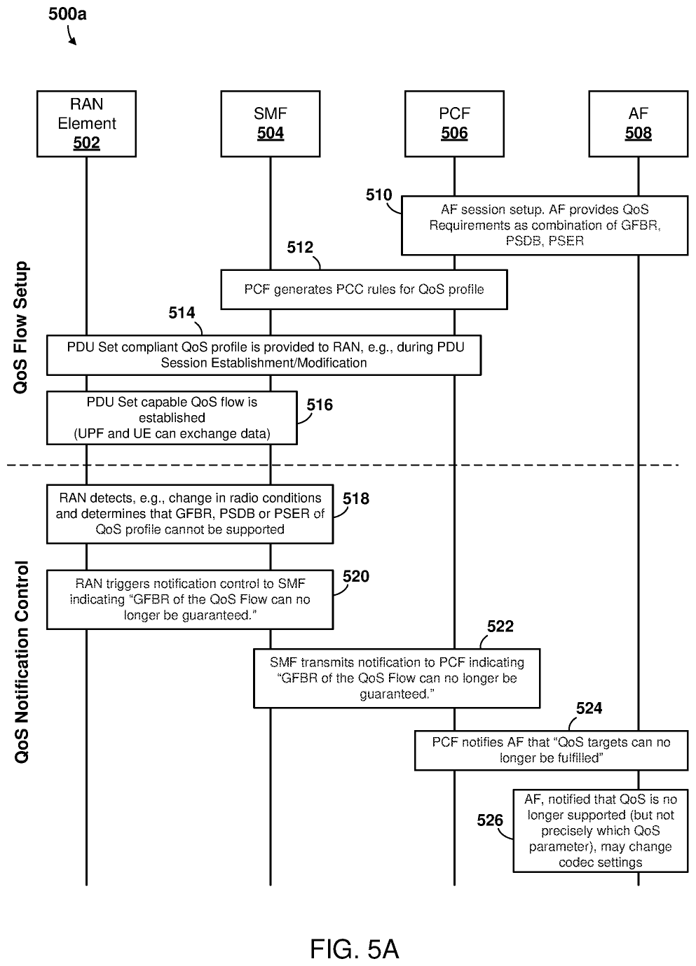

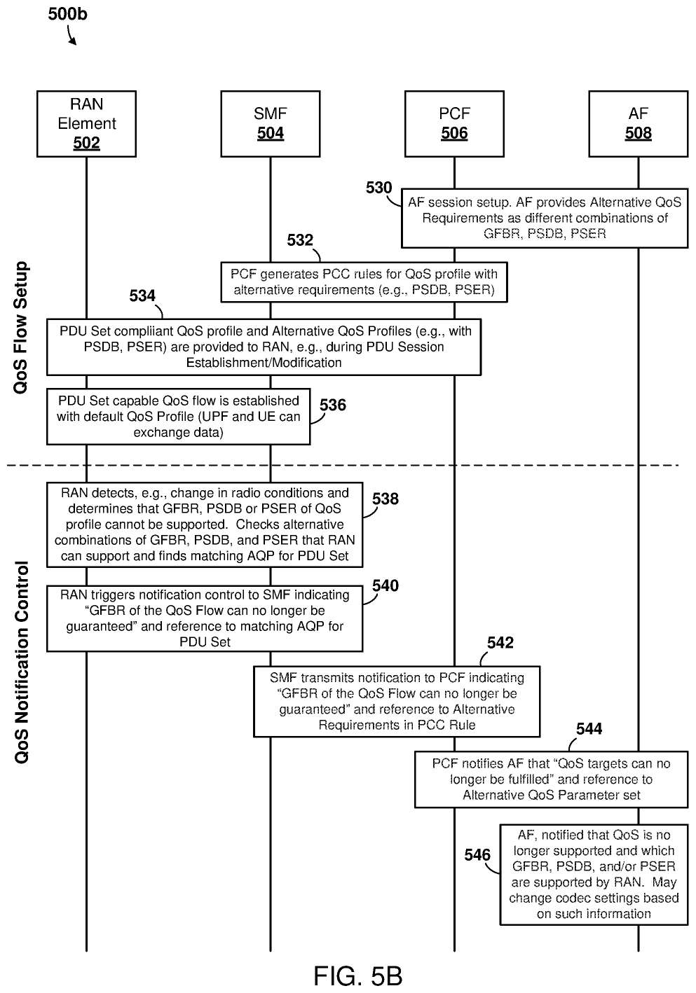

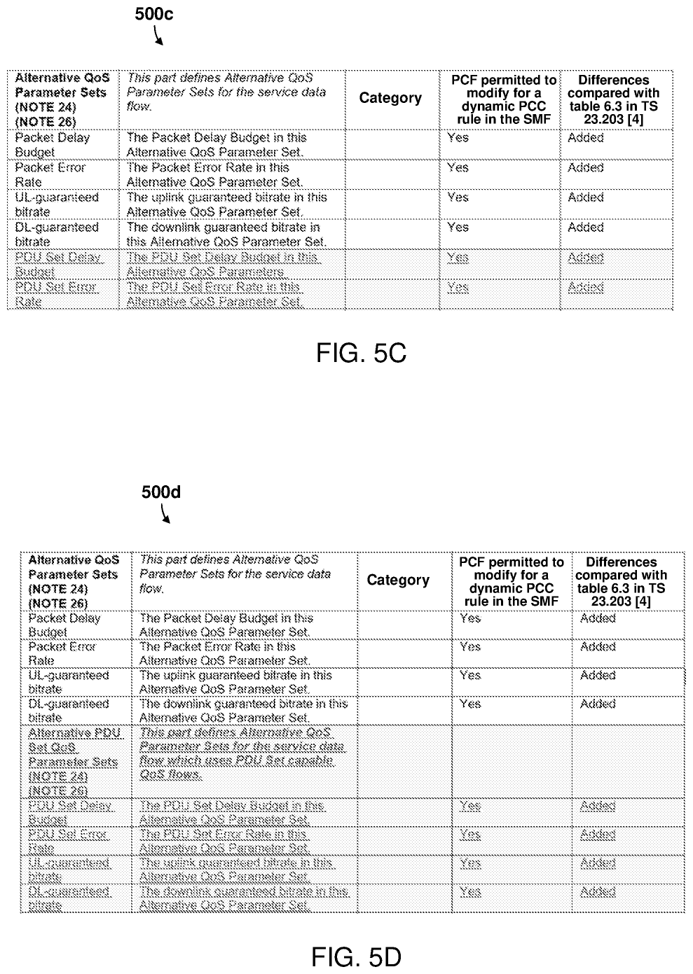

FIG. 5A is a message flow diagram illustrating operations 500a of QoS flow set up and notification control according to various aspects. With reference to FIGS. 1A-5A, the operations 500a may be performed by network elements including a RAN element 502 (e.g., 160, 191, 350, 400a), an SMF 504 (e.g., 189, or another suitable CN element), a PCF 506 (e.g., 188, or another suitable CN element), and an AF 508 (e.g., 185). The operations 500a may include two general phases of operations, a QoS flow set up phase, and a QoS notification control phase.

In block 510, the AF 508 and the PCF 506 may perform operations to set up an AF session for a QoS flow. In some implementations, the AF 508 may provide to the PCF 506 QoS requirements for the QoS flow that may include a combination of GFBR, PSDB, and PSER values.

In block 512, the PCF 506 may perform operations to generate Policy and Charging Control (PCC) rules for a QoS Profile applicable to the QoS flow. The PCF 506 may send the PCC rules to the SMF 504.

In block 514, the PCF 506 may perform operations to provide the PDU Set compliant QoS Profile applicable to the QoS flow to the RAN element 502. In some implementations, the PCF 506 may provide the QoS Profile to the RAN element 502 during the performance of operations for PDU session establishment or PDU session modification.

In block 516, the SMF 504 and the RAN element 502 perform operations to establish a QoS Flow transporting PDU Sets (i.e., a PDU Set capable QoS flow). A UPF (e.g., 187) and a UE (e.g., 120a-120e, 192, 200, 320) may transmit and/or receive data via the established QoS flow.

The RAN element 502 may monitor various parameters of a wireless communication link (i.e., radio conditions) between the UE and the RAN element 502. In block 518, the RAN element 502 may perform operations to detect, for example, a change in such radio conditions. The RAN element 502 may determine that a QoS parameter such as a PSDB value, a PSER value, or a GFBR value of the QoS Profile can no longer be supported and thus can no longer be guaranteed because of the change in the radio conditions.

In block 520, in response to determining that the PSDB value, PSER value, or GFBR value can no longer be supported and thus can no longer be guaranteed by the RAN element 502, the RAN element 502 may trigger (generate, transmit, send) a notification control signal or message to the SMF 504 indicating a suitable message such as “GFBR of the QoS flow can no longer be guaranteed.”

In block 522, the SMF 504 may transmit a notification to the PCF 506 indicating a suitable message such as “GFBR of the QoS flow can no longer be guaranteed.”

In block 524, the PCF 506 may send a notification message or signal to the AF 508 indicating a suitable message such as “QoS targets can no longer be fulfilled” for the QoS flow.

In block 526, in response to receiving the notification message or signal from the PCF 506, the AF 508 may change codec settings related to the QoS flow. In some implementations, the notification message or signal from PCF 506 may not indicate which QoS parameter can no longer be supported and thus can no longer be guaranteed by the RAN element 502.

FIG. 5B is a message flow diagram illustrating operations 500b of QoS flow set up and notification control according to various aspects. With reference to FIGS. 1A-5B, the operations 500b may be performed by network elements including a RAN element 502 (e.g., 160, 191, 350, 400a), an SMF 504 (e.g., 189, or another suitable CN element), a PCF 506 (e.g., 188, or another suitable CN element), and an AF 508 (e.g., 185). The operations 500b may include two general phases of operations, a QoS flow set up phase, and a QoS notification control phase. In some implementations, the operations 500b may enable various network elements (e.g., the RAN element 502, the SMF 504, the PCF 506, the AF 508, and/or other suitable network elements) to perform operations for QoS flow set up and QoS notification control employing AQPs for PDU Set-capable QoS flows.

In block 530, the AF 508 and the PCF 506 may perform operations to set up an AF session for a QoS flow. In some implementations, the AF 508 may provide to the PCF 506 various Alternative QoS Requirements for the QoS flow that may include different combinations of GFBR, PSDB, and PSER values.

In block 532, the PCF 506 may perform operations to generate PCC rules for a default QoS Profile applicable to the QoS flow and alternative requirements for various QoS parameters (e.g., PSDB, PSER). The PCF 506 may send the PCC rules to the SMF 504.

In block in block 534, the PCF 506 may perform operations to provide the default PDU Set compliant QoS Profile applicable to the QoS flow and Alternative QoS Profiles (e.g., with different PSDB values, PSER values, etc.) to the RAN element 502. In some implementations, the PCF 506 may provide the QoS Profile and the Alternative QoS Profiles to the RAN element 502 during the performance of operations for PDU session establishment or PDU session modification.

In block 536, the SMF 504 and the RAN element 502 perform operations to establish a QoS Flow transporting PDU Sets (i.e., a PDU Set capable QoS flow) using the default QoS Profile. A UPF (e.g., 187) and a UE (e.g., 120a-120e, 192, 200, 320) may transmit and/or receive data via the established QoS flow.

The RAN element 502 may monitor various parameters of a wireless communication link (i.e., radio conditions) between the UE and the RAN element 502. In block 538, the RAN element 502 may perform operations to detect, for example, a change in such radio conditions. The RAN element 502 may determine that a QoS parameter such as a PSDB value, a PSER value, or a GFBR value of the QoS Profile can no longer be supported and thus can no longer be guaranteed because of the change in the radio conditions. For example, if the default QoS Profile of the QoS Flow indicated PSDB, PSER and GFBR equal to 50 ms, 10⁻⁵ and 100 Mbps, respectively, and the RAN initially supported such combination of values of PDU Set QoS parameters, the RAN may now determine that due to, e.g., bad radio conditions, it can now support a PSDB value not lower than 100 ms. The RAN element 502 also may check (evaluate, test) various combinations of PSDB values, PSER values, and GFBR values that the RAN element 502 can support, and may run an algorithm to determine if any of the AQPs for a PDU Set of the QoS Flow that matches (corresponds with) a PSDB value, PSER value, and GFBR value that the RAN element 502 can support. With the previous example, assuming in step 534 the CN node previously indicated, in addition to the default QoS Profile, AQP #1 with PSDB, PSER and GFBR equal to 100 ms, 10⁻⁵ and 100 Mbps, respectively, AQP #2 with PSDB, PSER and GFBR equal to 50 ms, 10⁻⁵ and 50 Mbps and AQP #3 with PSDB, PSER and GFBR equal to 50 ms, 10⁻⁴ and 100 Mbps, then in this case the RAN can run an algorithm to compare the currently supported QoS parameters values combinations against the each previously provided AQPs. In this case, the RAN node would determine that AQP #1 is matching the currently supported combination of PDU Set QoS parameters.

In block 540, in response to determining that the PSDB value, PSER value, or GFBR value can no longer be supported and thus can no longer be guaranteed by the RAN element 502, the RAN element 502 may trigger (generate, transmit, send) a notification control signal or message to the SMF 504 indicating a suitable message such as “GFBR of the QoS flow can no longer be guaranteed.” The notification control signal generated by the RAN element 502 also may include a reference (indication, identification, index) to the matching (corresponding) AQP for the PDU Set. In the example described above, the RAN would indicate a reference to AQP #1.

In block 542, the SMF 504 may transmit a notification to the PCF 506 indicating a suitable message such as “GFBR of the QoS flow can no longer be guaranteed.” The notification transmitted by the SMF 504 also may include a reference (indication, identification, index) to Alternative Service Requirements in the PCC rule. In the example described above, the SMF would indicate a reference to the Alternative Service Requirements associated with AQP #1.

In block 544, the PCF 506 may transmit a notification message or signal to the AF 508 indicating a suitable message such as “QoS targets can no longer be fulfilled” for the QoS flow. The notification message transmitted by the PCF 506 also may include a reference (indication, identification, index) to an Alternative QoS Parameter set. In the example described above, the PCF would indicate a reference to the Alternative Parameter set associated with the Alternative Service Requirements associated with AQP #1.

In block 546, the AF 508 may receive the notification message or signal from the PCF 506, including information as to which PSDB, PSER, and/or GFBR can be supported by the RAN element 502. Based on such information, the AF 508 may change codec settings related to the QoS flow.

FIGS. 5C and 5D are tables 500c and 500d illustrating example Alternative QoS Parameters and Alternative QoS Parameter Sets configured for use with PDU Sets according to various aspects based on tables in ETSI technical specification (TS) 123.503. Alternative QoS Parameter Set(s) may define alternative set(s) of QoS parameters for a service data flow that requires a PDU Set-capable QoS flow. In some implementations, Alternative PDU Set QoS Parameter Sets (i.e., Alternative QoS Parameter Sets configured for use with PDU Sets/PDU Set-capable QoS flows) may include a PSER, a PSDB, an uplink guaranteed bit rate QoS parameter, and a downlink guaranteed bit rate QoS parameter.

Referring to FIG. 5C, in some examples, Alternative QoS Parameter Sets (illustrated in underlines) may include a PDU Set Delay Budget and a PDU Set Error Rate. Referring to FIG. 5D, in some examples, Alternative PDU Set QoS Parameter Sets (illustrated in underlines) may include a PDU Set Delay Budget, a PDU Set Error Rate, a guaranteed uplink bit rate (UL-guaranteed), and a guaranteed downlink bit rate (DL-guaranteed). The alternative QoS parameters illustrated in tables 500c and 500d are merely exemplary, and Alternative QoS Parameters may be implemented using a variety of names, labels, values, etc. without limitation.

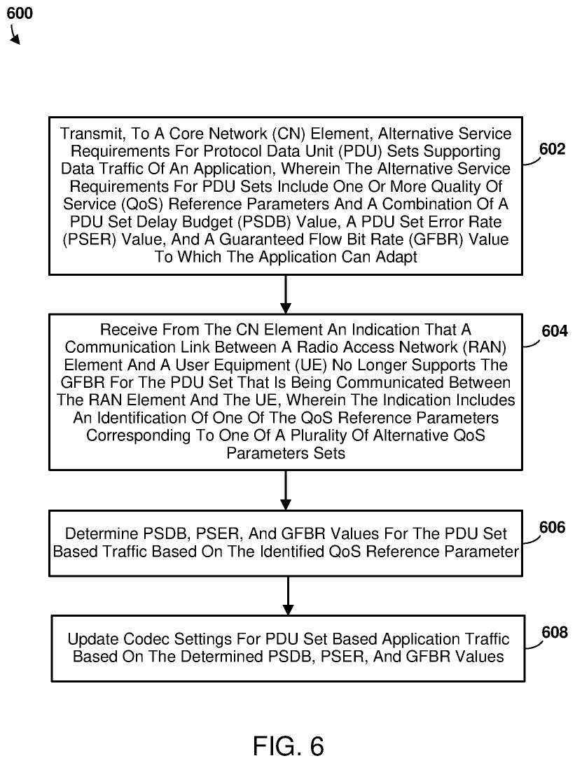

FIG. 6 is a process flow diagram illustrating a method 600 for QoS management for PDU Sets according to various implementations and aspects. With reference to FIGS. 1A-6, the operations of the method 600 may be performed by a processor (such as the one or more processors 210, 212, 214, 216, 218, 252, 260) of an application function (AF) (such as the AF 185, 400a, 508).

In block 602, the one or more processors may transmit to a Policy Control Function (PCF), Alternative Service Requirements for Protocol Data Unit (PDU) Sets supporting data traffic of an application. In some aspects, the Alternative Service Requirements for PDU Sets may include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt. In some implementations, different Alternative Service Requirements for PDU Sets may include different combinations of PSDB, PSER, and GFBR values to which the application can adapt. In some implementations, the different combinations of PSDB, PSER, and GFBR values may be arranged or represented in a prioritized order in each of the Alternative Service Requirements. In some implementations, the QoS reference parameters may include a bit rate, a delay budget, and an error rate applicable to the PDU Set. Means for performing operations of block 602 may include the one or more processors 210, 212, 214, 216, 218, 252, and 260, the wireless transceiver 266, and the communication manager 404.

In block 604, the one or more processors may receive from the PCF an indication that a communication link between a Radio Access Network (RAN) element and a user equipment (UE) can no longer support and thus can no longer guarantee the GFBR for the PDU Set that is being communicated between the RAN element and the UE. It some aspects, the indication may include an identification of one of the QoS reference parameters corresponding to one of a plurality of Alternative QoS Parameters Sets. Means for performing operations of block 604 may include the one or more processors 210, 212, 214, 216, 218, 252, and 260, the wireless transceiver 266, and the communication manager 404.

In block 606, the one or more processors may determine PSDB, PSER, and GFBR values for the PDU Set based traffic based on the identified QoS reference parameter. Means for performing operations of block 606 may include the one or more processors 210, 212, 214, 216, 218, 252, and 260, the wireless transceiver 266, and the communication manager 404.

In block 608, the one or more processors may update codec settings for the PDU Set based application traffic based on the determined PSDB, PSER, and GFBR values. Means for performing operations of block 608 may include the one or more processors 210, 212, 214, 216, 218, 252, and 260, the wireless transceiver 266, and the communication manager 404.

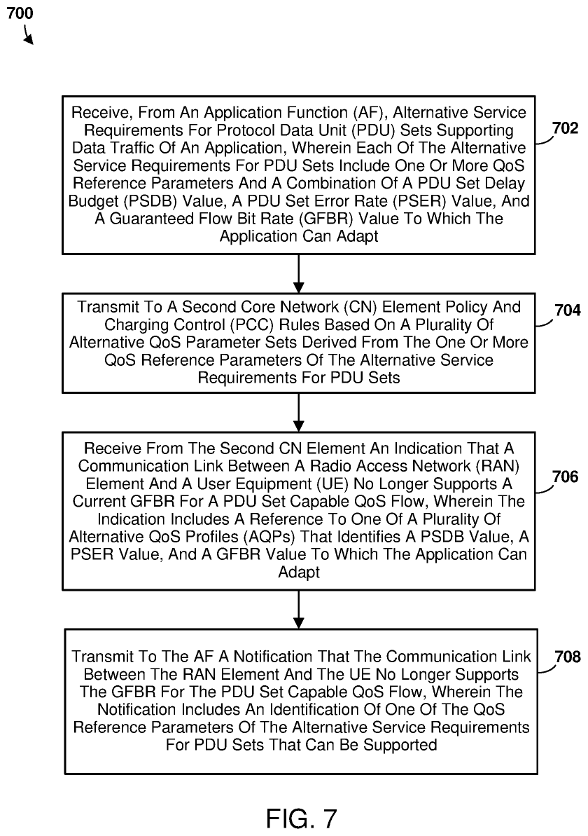

FIG. 7 is a process flow diagram illustrating a method 700 for QoS management for PDU Sets according to various implementations and aspects. With reference to FIGS. 1A-7, the operations of the method 700 may be performed by a processor (such as the one or more processors 210, 212, 214, 216, 218, 252, 260) of a core network (CN) element (such as the PCF 188, 400b, 506, or another suitable network element).

In block 702, the one or more processors may receive, from an Application Function (AF), Alternative Service Requirements for Protocol Data Unit (PDU) Sets supporting data traffic of an application. In some aspects, each of the Alternative Service Requirements for PDU Sets may include one or more QoS reference parameters and a combination of a PDU Set Delay Budget (PSDB) value, a PDU Set Error Rate (PSER) value, and a Guaranteed Flow Bit Rate (GFBR) value to which the application can adapt. Means for performing operations of block 702 may include the one or more processors 210, 212, 214, 216, 218, 252, and 260, the wireless transceiver 266, and the communication manager 422.

In block 704, the one or more processors may transmit to a Session Management Function (SMF) Policy and Charging Control (PCC) rules based on a plurality of Alternative QoS parameter sets derived from the one or more QoS reference parameters of the Alternative Service Requirements for PDU Sets. Means for performing operations of block 704 may include the one or more processors 210, 212, 214, 216, 218, 252, and 260, the wireless transceiver 266, and the communication manager 422.

In block 706, the one or more processors may receive from the SMF an indication that a communication link between a Radio Access Network (RAN) element and a user equipment (UE) longer supports and thus can no longer guarantee a current GFBR for a QoS Flow transporting PDU Sets (i.e., a PDU Set capable QoS flow). In some aspects, the indication may include a reference to one of a plurality of Alternative QoS Profiles (AQPs) that identifies a PSDB value, a PSER value, and a GFBR value to which the application can adapt. Means for performing operations of block 706 may include the one or more processors 210, 212, 214, 216, 218, 252, and 260, the wireless transceiver 266, and the communication manager 422.

In block 708, the one or more processors may transmit to the AF a notification that the communication link between the RAN element and the UE no longer supports and thus can no longer guarantee the GFBR for the QoS Flow transporting PDU Sets (i.e., a PDU Set capable QoS flow). In some aspects, the notification may include an identification of one of the QoS reference parameters of the Alternative Service Requirements for PDU Sets that can be supported. Means for performing operations of block 708 may include the one or more processors 210, 212, 214, 216, 218, 252, and 260, the wireless transceiver 266, and the communication manager 422.

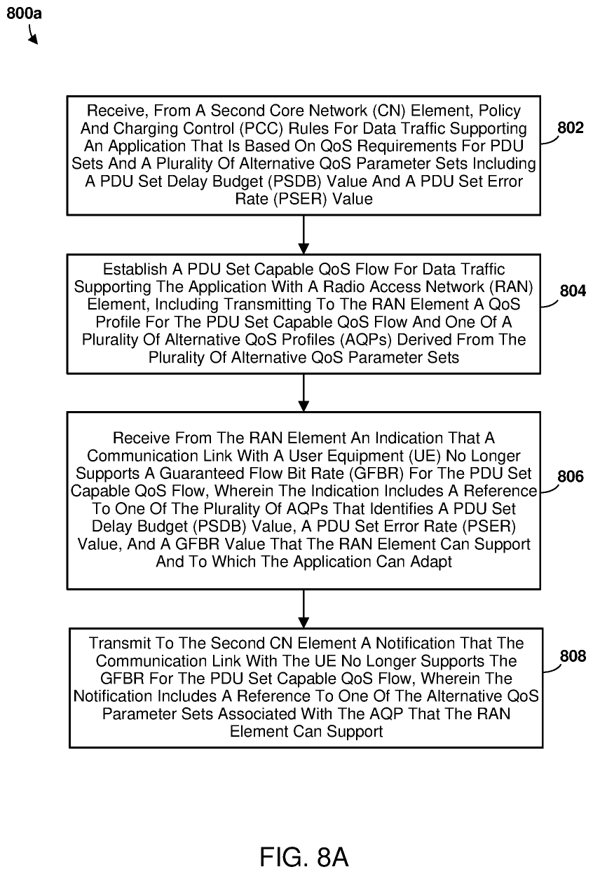

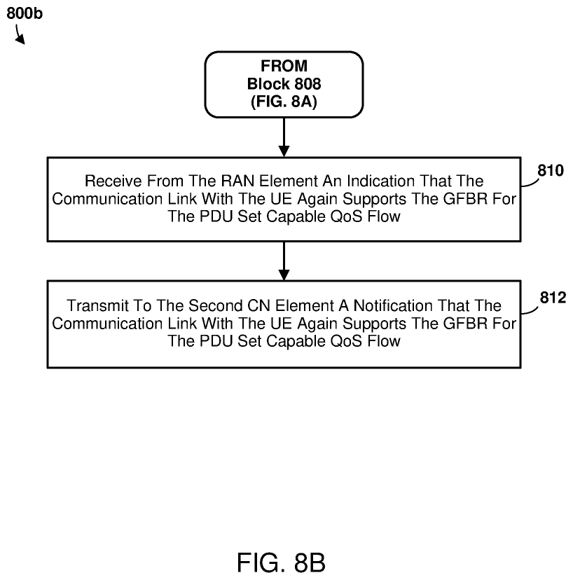

FIG. 8A is a process flow diagram illustrating a method 800a for QoS management for PDU Sets according to various implementations and aspects. With reference to FIGS. 1A-8A, the operations of the method 800a may be performed by a processor (such as the one or more processors 210, 212, 214, 216, 218, 252, 260) of a core network (CN) element (such as the SMF 189, 400c, 504, or another suitable network element).

In block 802, the one or more processors may receive, from a Policy Control Function (PCF), Policy and Charging Control (PCC) rules for data traffic supporting an application that is based on QoS requirements for a PDU Set and a plurality of Alternative QoS parameter sets including a PDU Set Delay Budget (PSDB) value and a PDU Set Error Rate (PSER) value. Means for performing operations of block 802 may include the one or more processors 210, 212, 214, 216, 218, 252, and 260, the wireless transceiver 266, and the communication manager 442.

In block 804, the one or more processors may establish a QoS Flow transporting PDU Sets (i.e., a PDU Set capable QoS flow) for data traffic supporting the application with a Radio Access Network (RAN) element for a PDU Set, including transmitting or otherwise providing to the RAN element a QoS profile for the PDU Set and one of a plurality of Alternative QoS Profiles (AQPs) derived from the plurality of Alternative QoS parameter sets. Means for performing operations of block 804 may include the one or more processors 210, 212, 214, 216, 218, 252, and 260, the wireless transceiver 266, and the communication manager 442.

In block 806, the one or more processors may receive from the RAN element an indication that a communication link with a user equipment (UE) no longer supports and thus can no longer guarantee a Guaranteed Flow Bit Rate (GFBR) for the QoS Flow transporting PDU Sets. In some aspects, the indication may include a reference to one of the plurality of AQPs that identifies a PDU Set Delay Budget (PSDB) value, a PDU Set Error Rate (PSER) value, and a GFBR value that the RAN element can support and to which the application can adapt. Means for performing operations of block 806 may include the one or more processors 210, 212, 214, 216, 218, 252, and 260, the wireless transceiver 266, and the communication manager 442.

In block 808, the one or more processors may transmit to the PCF a notification that the communication link with the UE no longer supports and thus can no longer guarantee the GFBR for the QoS Flow transporting PDU Sets. In some aspects, the notification may include a reference to one of the Alternative QoS parameter sets associated with the AQP that the RAN element can support. Means for performing operations of block 808 may include the one or more processors 210, 212, 214, 216, 218, 252, and 260, the wireless transceiver 266, and the communication manager 442.

FIG. 8B is a process flow diagram illustrating operations 800b that may be performed as part of the 800a for QoS management for PDU Sets according to various implementations and aspects. With reference to FIGS. 1-8B, the operations 800b may be performed by a processor (such as the one or more processors 210, 212, 214, 216, 218, 252, 260) of a core network (CN) element (such as the SMF 189, 400c, 504, or another suitable network element).

After the one or more processors transmits to the PCF a notification that the communication link with the UE no longer supports and thus can no longer guarantee the GFBR for the PDU Set in block 808 as described, the one or more processors may receive from the RAN element an indication that the communication link with the UE again supports and thus can guarantee again the GFBR for the QoS Flow transporting PDU Sets in block 810. Means for performing operations of block 810 may include the one or more processors 210, 212, 214, 216, 218, 252, and 260, the wireless transceiver 266, and the communication manager 442.

In block 812, the one or more processors may transmit to the PCF a notification that the communication link with the UE again supports and thus can guarantee again the GFBR for the QoS Flow transporting PDU Sets. Means for performing operations of block 812 may include the one or more processors 210, 212, 214, 216, 218, 252, and 260, the wireless transceiver 266, and the communication manager 442.

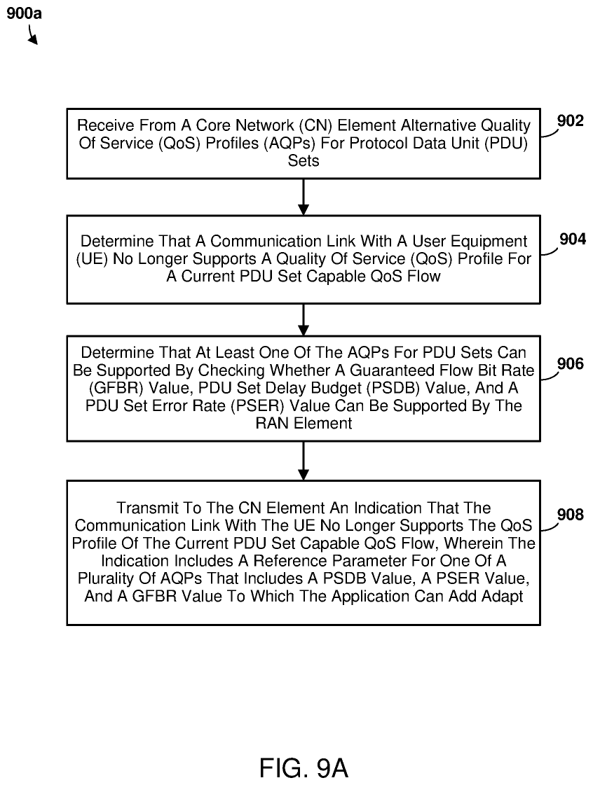

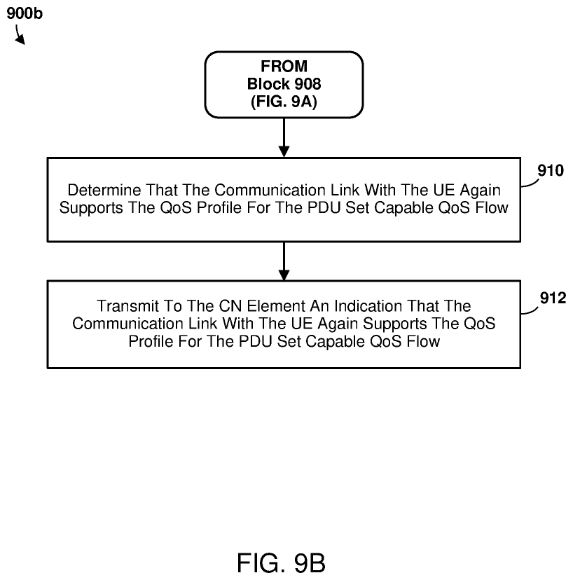

FIG. 9A is a process flow diagram illustrating a method 900a for QoS management for PDU Sets according to various implementations and aspects. With reference to FIGS. 1A-9A, the operations of the method 900a may be performed by a processor (such as the one or more processors 210, 212, 214, 216, 218, 252, 260) of a RAN element (e.g., 110a-110d, 162, 170, 172, 174, 191, 200, 350, 400d, 502).

In block 902, the one or more processors may receive from a core network (CN) element Alternative quality of service (QoS) Profiles (AQPs) for Protocol Data Unit (PDU) Sets. Means for performing operations of block 902 may include the one or more processors 210, 212, 214, 216, 218, 252, and 260, the wireless transceiver 266, and the communication manager 462.

In block 904, the one or more processors may determine that a communication link with a user equipment (UE) no longer supports and thus can no longer guarantee a quality of service (QoS) profile for a current QoS Flow transporting PDU Sets (i.e., a PDU Set capable QoS flow). Means for performing operations of block 904 may include the one or more processors 210, 212, 214, 216, 218, 252, and 260, the wireless transceiver 266, and the communication manager 462.

In block 906, the one or more processors may determine that at least one of the AQPs for PDU Sets can be supported by checking whether a Guaranteed Flow Bit Rate (GFBR) value, PDU Set Delay Budget (PSDB) value, and a PDU Set Error Rate (PSER) value can be supported by the RAN element. Means for performing operations of block 906 may include the one or more processors 210, 212, 214, 216, 218, 252, and 260, the wireless transceiver 266, and the communication manager 462.

In block 908, the one or more processors may transmit to the CN element an indication that the communication link with the UE no longer supports and thus can no longer guarantee the QoS profile for the QoS flow of the current QoS Flow transporting PDU Sets. In some aspects, the indication includes a reference parameter for one of a plurality of AQPs that includes a PSDB value, a PSER value, and a GFBR value to which the application can add adapt. Means for performing operations of block 906 may include the one or more processors 210, 212, 214, 216, 218, 252, and 260, the wireless transceiver 266, and the communication manager 462.

FIG. 9B is a process flow diagram illustrating operations 900b that may be performed as part of the method 900a for QoS management for PDU Sets according to various implementations and aspects. With reference to FIGS. 1-9B, the operations 900b may be performed by a processor (such as the one or more processors 210, 212, 214, 216, 218, 252, 260) of a RAN element (e.g., 110a-110d, 162, 170, 172, 174, 191, 200, 350, 400d, 502).

After the one or more processors transmits or otherwise provides to the CN element an indication that the communication link with the UE no longer supports and thus can no longer guarantee the QoS profile for the QoS flow of the current PDU Set that is being communicated between the RAN element and the UE in block 908 as described, the one or more processors may determine that the communication link with the UE again supports and thus can guarantee again the QoS profile for the QoS Flow transporting PDU Sets. Means for performing operations of block 910 may include the one or more processors 210, 212, 214, 216, 218, 252, and 260, the wireless transceiver 266, and the communication manager 462.

In block 912, the one or more processors may transmit to the CN element an indication that the communication link with the UE again supports and thus can guarantee again the QoS profile for the QoS Flow transporting PDU Sets. Means for performing operations of block 912 may include the one or more processors 210, 212, 214, 216, 218, 252, and 260, the wireless transceiver 266, and the communication manager 462.

In a further additional or alternative aspect, wireless communications network operations may be implemented in one or more network elements for communicating information when there is a change in the bit rate or frame rate on an application executing on the UE, establishing new QoS parameters that will support a new bit rate or frame rate for the application, and configuring communication parameters to implement the new QoS parameters to support data communications to/from the UE application at the new bit rate or frame rate. These operations enable switching to QoS parameters in the communication link to support the new bit rate or frame rate of the application without the delay of renegotiating QoS requirements.

Many applications that are executed by a network computing device (such as an application server) have the capability to adapt a bit rate or frame rate of a data flow in response to variations in the quality of service (QoS) of communication links that convey the data flow, such as available bandwidth, a data delay, or a data loss rate. Configurations of user equipment (UE) with which the network computing device communicates data flow(s) may depend on traffic patterns of the data flow(s) that may be communicated to/from the UE via a radio access network (RAN). For example, extended reality (XR) applications (e.g., virtual reality (VR) applications, augmented reality (AR) applications, mixed reality (MX) applications, and other similar applications) may exhibit highly variable traffic patterns that include periodic bursts of data traffic requiring a high bit rate or frame rate interspersed with periods of modest data traffic that can be handled with lower bit rates or frame rates. As used herein, the term “bit rate” refers to an amount of information (which may be expressed in bits) that may be conveyed per a unit of time. As used herein, the term “frame rate” refers to an amount of information, typically image, audio, video, or multimedia information (which may be expressed in “frames” or another suitable measurement of information), that may be conveyed per a unit of time.

In 5G communication systems, a QoS model is based on QoS flows. A QoS flow is the finest level of granularity within a 5G communication system and is the level at which policy and charging are enforced. QoS flow protocol data units (PDUs, e.g., packets) are classified and marked using a unique QoS Flow Identifier. to enable the application of QoS requirement on a data flow.

To support data traffic of applications exhibiting variable data transmission rates, communication links with a UE may be configured in a way that coordinates with a traffic pattern generated by the application. For example, a periodicity of a UE's discontinuous reception (DRX) parameters, semi-persistent scheduling (SRS) parameters, and/or configured grant (CG) parameters may be configured based on the periodicity (e.g., a frame rate) of the application's data traffic. As another example, the UE's logical channel prioritization (LCP) parameters may be configured based on a bit rate of the application's data traffic.

However, such adaptation by applications (e.g., application server) and application receivers (e.g., UEs) is performed at the application layer (e.g., Layer 7 of the Open System Interconnection (OSI) model) between the application server and the UE. Some systems do not provide a mechanism for a Radio Access Network (RAN) to adapt configurations of the UE to coordinate with adaptations performed by the application server. In the event of a mismatch between the traffic pattern of a data flow and UE configurations, the system may be unable to meet QoS requirements of the data flow.

In various aspects, an application function (AF), a core network (CN) element, a RAN element, and a UE may perform operations to coordinate rate adaptation in anticipation of a change to a bit rate or frame rate of a data flow.

In some aspects, the data flow may include a large proportion of downlink traffic (e.g., from the application to the UE). In such aspects, the application (e.g., executing at an application server or another suitable network element) may transmit an indication to the AF that the application will change the bit rate or frame rate of a data flow. In some aspects, the indication also may include the new bit rate and/or frame rate. In some aspects, the AF may provide or forward the indication to the RAN element. In some aspects, the AF may signal the indication to the RAN element in a reestablishment (renegotiation) of a QoS flow with the RAN element. In some examples, the AF may forward a modification of the QoS flow from the application (executing at the application server). In some aspects, the AF may transmit a signal to the RAN element that effects an bit rate change responsive to the signal (for example, substantially immediately after receiving such signal). In some aspects, the RAN element may reconfigure a communication parameter of the UE based on the new bit rate and/or frame rate of the data flow. In some examples, a UE configuration parameter may include one or more of discontinuous reception (DRX) parameters, semi-persistent scheduling (SPS) parameters, configured grant (CG) parameters, and/or logical channel prioritization (LCP) parameters. In some aspects, the RAN element may perform a Radio Resource Control (RRC) Reconfiguration procedure to reconfigure the communication parameter(s) of the UE. In some aspects, the RAN element may pre-configure a set of candidate communication parameter(s) of the UE. In such aspects, the RAN element may transmit to the UE a medium access control-control element (MAC CE) that includes an indication of which candidate communication parameter(s) to use.

In some aspects, the data flow may include a large proportion of uplink traffic (e.g., from the UE to the application). In such aspects, the application may transmit an indication to the UE that the application will change the bit rate or frame rate of a data flow. In some aspects, the indication may include the new bit rate and or frame rate to which the application will change. In some aspects, the UE may transmit a reconfiguration request to the RAN element. The reconfiguration request may include the new bit rate and/or frame rate indicated by the application. In some aspects, the UE may transmit the reconfiguration request via an RRC message (for example, a UE Assistance Information message) or via a MAC CE. The RAN element may reconfigure a communication parameter of the UE based on the new bit rate and/or frame rate of the data flow. In some examples, the RAN element may reconfigure one or more of DRX parameters, SPS parameters, CG parameters, and/or LCP parameters of the UE. In some aspects, the RAN element may perform a Radio Resource Control (RRC) Reconfiguration procedure to reconfigure the communication parameter(s) of the UE. In some aspects, the RAN element may transmit to the UE a medium access control-control element (MAC CE) to reconfigure the communication parameter(s) of the UE.

In various aspects, after successful reconfiguration of the UE communication parameter(s) by the RAN, the RAN element may transmit a confirmation message to the application. After receiving the confirmation message from the RAN, the application may implement (apply) the change to the bit rate and/or frame rate of the data flow (i.e., transmit the data flow using the new bit rate and/or frame rate).

In some aspects, the RAN element and the UE may each perform operations to coordinate the timing of implementing (applying, using) the new bit rate and/or frame rate. To minimize a duration of mismatch between the traffic pattern of the data flow and the UE's communication parameter settings (i.e., the UE's configurations), the RAN element and the UE may each perform operations so that a change in the data flow traffic pattern caused by the new bit rate and/or frame rate and the change in the UE's configurations are implemented (applied, changed) close to or substantially at the same time (i.e., within a very short time interval). In some aspects, the RAN element may implement the new bit rate and/or frame rate and the UE may use the updated (reconfigured) UE communication parameter(s) no earlier than a first time (T1) after the RAN element receives the UE's confirmation message of RRC reconfiguration or the UE's MAC CE, and no later than a second time (T2) after the RAN element receives the UE's confirmation message of RRC reconfiguration or the UE's MAC CE. In such aspects, the first time T1 and the second time T2 define a time interval during which the RAN element may implement the new bit rate and/or frame rate and the UE may implement the updated (reconfigured) UE communication parameter(s). In some aspects, the application may provide an indication of a target time by which, or a target time interval during which, the RAN element should implement the new bit rate and/or frame rate and the UE should implement the updated (reconfigured) UE communication parameter(s). In such aspects, the RAN element may implement the new bit rate and/or frame rate and the UE may implement the updated (reconfigured) UE communication parameter(s) by the indicated target time or during the indicated target time interval. In some aspects, the application may transmit to the AF the target time and/or the target time interval using an indication of absolute time (e.g., clock time), and the AF may convert the indication(s) of absolute time into an indication of network time (e.g., 5G network time), such as a slot, an index, or another time indication used by the communication network.

In various aspects, an element of a RAN (a “RAN element”) may receive an indication of a change in a bit rate or frame rate of the data flow between the AF and the UE. The RAN element may establish one or more Quality of Service (QoS) parameters with a core network (CN) element to support the change in a bit rate or frame rate of a data flow in response to receiving the indication. The RAN element may then transmit to the UE a configuration message that configures one or more UE communication parameters to implement the established QoS parameters. In some aspects, receiving the indication of the change in the bit rate or frame rate of the data flow may include receiving the indication from the UE. In some aspects, receiving an indication of the change in the bit rate or frame rate of the data flow may include receiving the indication from the AF via the CN element. In some aspects, the RAN element may receive from the UE a confirmation of the configuration message. After a time interval following receipt of the confirmation from the UE, the RAN element may transmit the data flow to the UE using the one or more UE communication parameters. In some aspects, transmitting or otherwise providing the application data flow by the RAN element to the UE using the one or more UE communication parameters after a time interval following receipt of the confirmation from the UE may include transmitting/providing the application data flow to the UE using the one or more UE communication parameters after a time interval following receipt of the confirmation from the UE. In some aspects, the one or more UE communication parameters may include one or more of DRX parameters, SPS parameters, CG parameters, or LCP parameters. In some aspects, negotiating QoS parameters with the CN element may include receiving from the CN element a reference parameter of one of a plurality of Alternative QoS Profiles (AQPs) that were previously negotiated with the CN element for a protocol data unit (PDU) set supporting the data flow. Some aspects may include negotiating the plurality of AQPs with the CN element as part of establishing the data flow to the UE, wherein each of the AQPs is associated with a reference parameter and supports a particular bit rate or frame rate for a communication link between the RAN element and the UE suitable for supporting the data flow. Some aspects may include transmitting/providing to the CN element a request for a reestablishment or update of the QoS parameters.

In various aspects, a CN element (e.g., one or more computing device elements of a core network) may receive an indication of a change in bit rate or frame rate of the data flow, and may negotiate Quality of Service (QoS) parameters with a Radio Access Network (RAN) element to implement the change in the bit rate or frame rate. In some aspects, receiving an indication of a change in bit rate or frame rate of the data flow may include receiving an indication from the UE of the change in the bit rate or frame rate of the data flow. In some aspects, receiving an indication of a change in bit rate or frame rate of the data flow may include receiving an indication of the change in the bit rate or frame rate of the data flow from an AF. Some aspects may include transmitting or otherwise providing a confirmation of the indication to an AF after completing the negotiation of the QoS parameters. In some aspects, negotiating QoS parameters with the RAN element may include transmitting/providing to the RAN element a reference parameter of one of a plurality of Alternative QoS Profiles (AQPs) that were previously negotiated with the RAN element for a protocol data unit (PDU) set supporting the data flow. Some aspects may include negotiating the plurality of AQPs with the RAN element as part of establishing the data flow to the UE, wherein each of the AQPs is associated with an identifier and supports a particular bit rate or frame rate for a communication link between the RAN element and the UE supporting the data flow. Some aspects may include receiving from the RAN element a request for a reestablishment or update of the QoS parameters, and adjusting the bit rate or frame rate for the data flow related to the request for reestablishment or update of the QoS parameters. Some aspects may include receiving from the RAN element a QoS notification control message, and renegotiating a QoS profile for the data flow with the RAN element related to the QoS notification control message.

In various aspects, a UE may transmit to a RAN element an indication of a change in a bit rate or frame rate of a data flow for an application client (AC) that is executing on the UE (such as a software application making use of the data flow and/or sending information of the data flow). The UE may receive from the RAN element a configuration message that configures one or more UE communication parameters to support the change in the bit rate or frame rate of the data flow, and the UE may adjust communications with the RAN element using the one or more UE communication parameters. In some aspects, transmitting/providing to the RAN element the indication of the change in the bit rate or frame rate of the data flow may include transmitting/providing the indication of the change in the bit rate or frame rate of the data flow via radio resource control (RRC) signaling or a medium access control-control element (MAC CE). In some aspects, transmitting/providing to the RAN element the indication of the change in the bit rate or frame rate of the data flow may include transmitting/providing an indication of a specified bit rate or frame rate of the data flow. Some aspects may include transmitting/providing to the RAN element a confirmation of receipt of the configuration message. In such aspects, adjusting communications with the RAN element using the one or more UE communication parameters may include adjusting communications with the RAN element using the one or more UE communication parameters after a time interval following the transmission of the confirmation to the RAN element. In some examples, the one or more UE communication parameters received from the RAN element may include one or more of DRX parameters, SPS parameters, CG parameters, or LCP parameters.

Various aspects improve network communication and wireless communications by enabling a UE, a RAN, and an application to coordinate data flow rate adaptation to reduce a mismatch between UE communication parameters (configuration) and a data rate or frame rate of the data flow. Various aspects improve network communication and wireless communications by enabling the RAN and the UE to meet QoS requirements of the data flow.

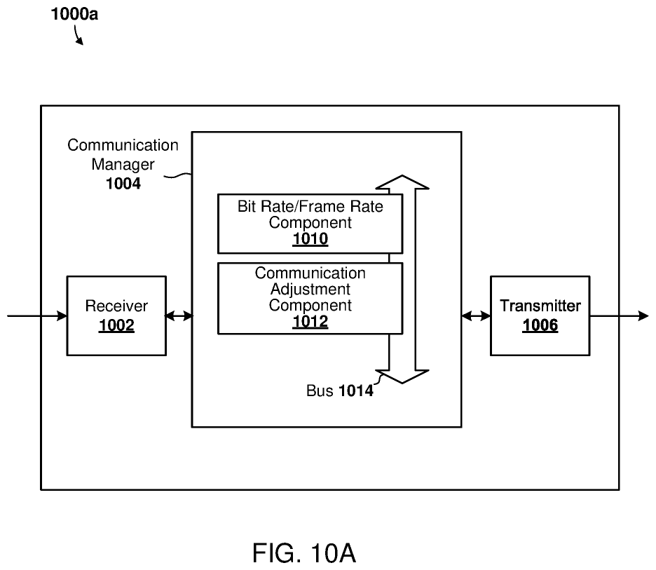

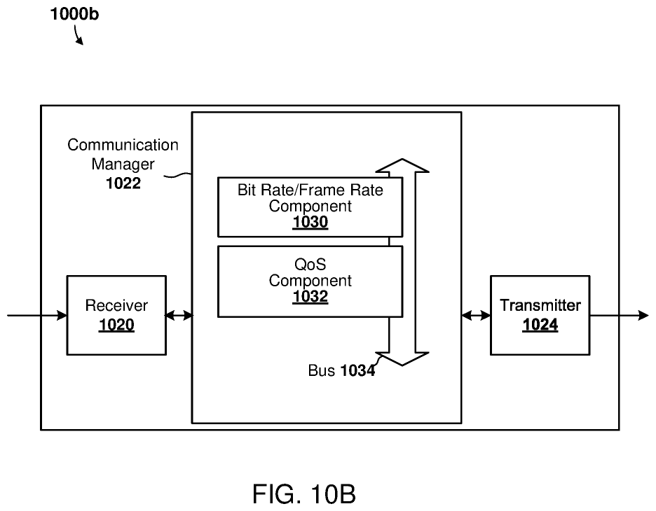

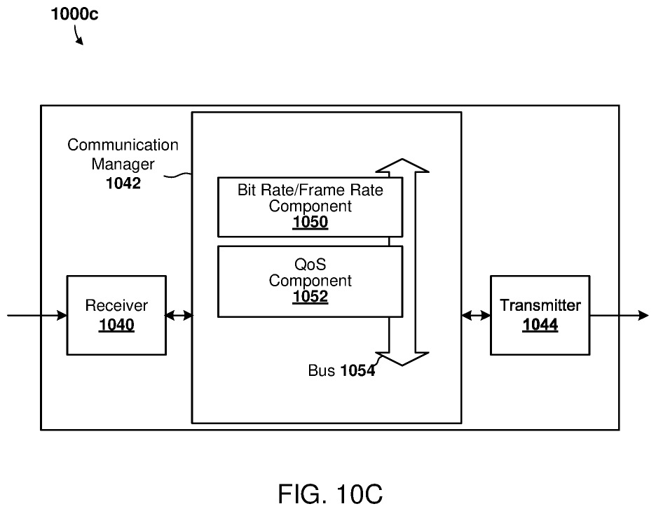

FIG. 10A is a block diagram illustrating a UE 1000a that supports wireless communications according to various aspects. With reference to FIGS. 1A-10A, the UE 1000a (e.g., 120a-120e, 192, 200, 320), the UE 1000a may be configured to communicate with an element of a RAN (e.g., 160, 191) (i.e., a RAN element). The UE 1000a may be configured with a receiver 1002, a communication manager 1004, and a transmitter 1006. The receiver 1002 may receive information, such as packets, control information, etc., associated with RF communications. The receiver 1002 may be an example of aspects of a transceiver 256 or 266. The transmitter 1002 may send information, such as packets, control information, etc., associated with RF communications. The transmitter 1002 may be an example of aspects of a transceiver 256 or 266.

The communication manager 1004 may be an example of aspects of processor 212, 214, 216, 218, 210, 252. The communication manager 1004 may include a bit rate/frame rate component 1010 and a communication adjustment component 1012, which may communicate over a communication bus 1014 or another suitable communication element. The communication manager 1004 may transmit to the RAN element an indication of a change in a bit rate or frame rate of a data flow for an application client (AC) executing on the UE. The communication manager 1004 may receive from the RAN element a configuration message that configures one or more UE communication parameters to support the change in the bit rate or frame rate of the data flow. The communication manager 1004 may adjust communications with the RAN element using the one or more UE communication parameters. The communication manager 1004 may transmit the indication of the change in the bit rate or frame rate of the data flow via radio resource control (RRC) signaling or a medium access control-control element (MAC CE). The communication manager 1004 may transmit an indication of a specified bit rate or frame rate of the data flow. The communication manager 1004 may transmit to the RAN element a confirmation of receipt of the configuration message. The communication manager 1004 may adjust communications with the RAN element using the one or more UE communication parameters after a time interval following the transmission of the confirmation to the RAN element.

FIG. 10B is a block diagram illustrating a RAN element 1000b that supports wireless communications according to various aspects. With reference to FIGS. 1A-10B, the RAN element 1000a (e.g., 110a-110d, 162, 170, 172, 174, 191, 200, 350), may be configured to communicate with a UE (e.g., 120a-120e, 192, 200, 320, 1000a) and a core network (e.g., 140, 180, 186). The RAN element 1000b may be configured with a receiver 1020, a communication manager 1022, and a transmitter 1024. The receiver 1020 may receive information, such as packets, control information, etc., associated with RF and network communications. The receiver 1002 may be an example of aspects of a transceiver 256 or 266, which may include wired and wireless communication components. The transmitter 1002 may send information, such as packets, control information, etc., associated with RF and network communications. The transmitter 1002 may be an example of aspects of a transceiver 256 or 266.

The communication manager 1022 may be an example of aspects of processor 212, 214, 216, 218, 210, 252. The communication manager 1022 may include a bit rate/frame rate component 1020 and a QoS component 1032, which may communicate over a communication bus 1034 or another suitable communication element. The communication manager 1022 may receive an indication of a change in a bit rate or frame rate of the data flow between an application function AF (e.g., 185) and a UE. The communication manager 1022 may negotiate one or more QoS parameters with a CN element to support the change in a bit rate or frame rate of a data flow in response to receiving the indication. The communication manager 1022 may transmit to the UE a configuration message that configures one or more UE communication parameters to implement the negotiated QoS parameters. The communication manager 1022 may receive the indication from the UE. The communication manager 1022 may receive the indication from the AF via the CN element. The communication manager 1022 may receive from the UE a confirmation of the configuration message, and may transmit the data flow to the UE using the one or more UE communication parameters after a time interval following receipt of the confirmation from the UE. The communication manager 1022 transmit the application data flow to the UE using the one or more UE communication parameters after a time interval following receipt of the confirmation from the UE. The communication manager 1022 may negotiate one or more QoS parameters with the CN element including receiving from the CN element a reference parameter of one of a plurality of Alternative QoS Profiles (AQPs) that were previously negotiated with the CN element for a protocol data unit (PDU) set supporting the data flow. The communication manager 1022 may negotiate the plurality of AQPs with the CN element as part of establishing the data flow to the UE, wherein each of the AQPs is associated with a reference parameter and supports a particular bit rate or frame rate for a communication link between the RAN and the UE suitable for supporting the data flow. The communication manager 1022 may transmit to the CN element a request for a reestablishment or update of the QoS parameters.

FIG. 10C is a block diagram illustrating a CN element 1000c that supports wireless communications according to various aspects. With reference to FIGS. 1A-10C, the CN element 1000c (e.g., 110a-110d, 162, 170, 172, 174, 191, 200, 350), may be configured to communicate with a RAN (e.g., 110a-110d, 162, 170, 172, 174, 191, 200, 350) and an application server (e.g., 184) and an AF (e.g., 185). (e.g., 140, 180, 186). The CN element 1000c may be configured with a receiver 1040, a communication manager 1042, and a transmitter 1044. The receiver 1040 may receive information, such as packets, control information, etc., associated with network communications. The receiver 1040 may be an example of aspects of a transceiver 256 or 266, which may include wired and wireless communication components. The transmitter 1044 may send information, such as packets, control information, etc., associated with network communications. The transmitter 1002 may be an example of aspects of a transceiver 256 or 266, which may include wired and wireless communication components.

The communication manager 1042 may be an example of aspects of processor 212, 214, 216, 218, 210, 252. The communication manager 1042 may include a bit rate/frame rate component 1050 and a QoS component 1052, which may communicate over a communication bus 1054 or another suitable communication element. The communication manager 1042 may receive an indication of a change in bit rate or frame rate of the data flow, and may negotiate one or more QoS parameters with a RAN element to implement the change in the bit rate or frame rate. The communication manager 1042 may receive an indication of the change in the bit rate or frame rate of the data flow from the UE. The communication manager 1042 may receive an indication of the change in the bit rate or frame rate of the data flow from an AF. The communication manager 1042 may transmit a confirmation of the indication to an AF after completing the negotiation of the QoS parameters. The communication manager 1042 may transmit to the RAN element a reference parameter of one of a plurality of Alternative QoS Profiles (AQPs) that were previously negotiated with the RAN for a protocol data unit (PDU) set supporting the data flow. The communication manager 1042 may negotiate the plurality of AQPs with the RAN element as part of establishing the data flow to the UE, in which each of the AQPs is associated with an identifier and supports a particular bit rate or frame rate for a communication link between the RAN and the UE supporting the data flow. The communication manager 1042 may receive from the RAN element a request for a reestablishment or update of the QoS parameters, and may adjust the bit rate or frame rate for the data flow related to the request for reestablishment or update of the QoS parameters. The communication manager 1042 may receive from the RAN element a QoS notification control message, and may renegotiate a QoS profile for the data flow with the RAN related to the QoS notification control message.

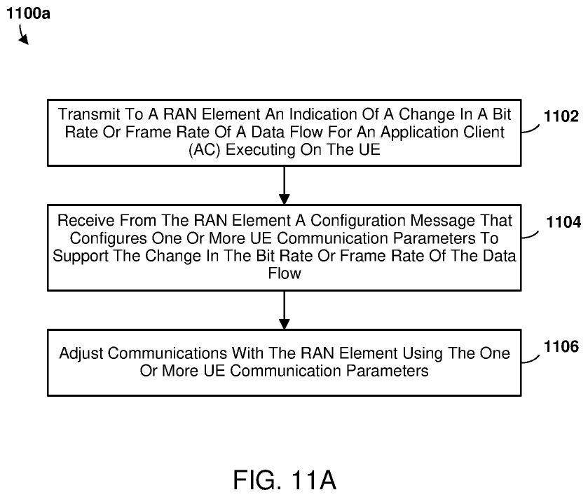

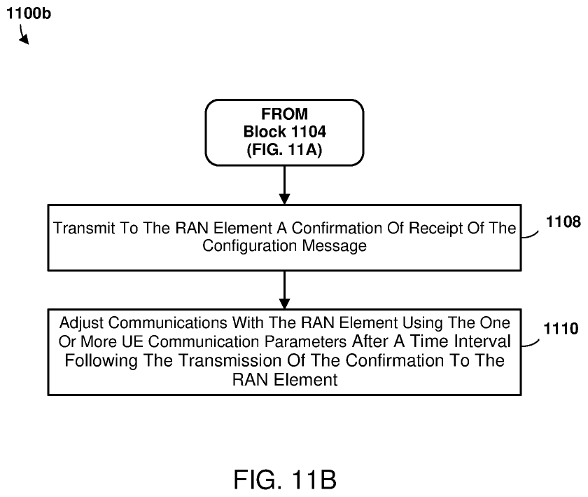

FIG. 11A is a process flow diagram illustrating a method 1100a for coordinating rate adaptation according to various aspects and aspects. With reference to FIGS. 1-11A, the operations of the method 1100a may be performed by a processor (such as the one or more processors 210, 212, 214, 216, 218, 252, 260, 274a) of a UE (such as the UE 120a-120e, 192, 200, 320, 1000a).

In block 1102, the one or more processors may transmit to a Radio Access Network (RAN) element an indication of a change in a bit rate or frame rate of a data flow for an application client (AC) executing on the UE. In some aspects, the one or more processors may transmit the indication of the change in the bit rate or frame rate of the data flow via radio resource control (RRC) signaling or a medium access control-control element (MAC CE). In some aspects, the one or more processors may transmit an indication of a specified bit rate or frame rate of the data flow. Means for performing operations of block 1102 may include the one or more processors 210, 212, 214, 216, 218, 252, and 260, the wireless transceiver 266, and the communication manager 1004.

In block 1104, the one or more processors may receive from the RAN element a configuration message that configures one or more UE communication parameters to support the change in the bit rate or frame rate of the data flow. In some aspects, the UE communication parameters received from the RAN element may include one or more of discontinuous reception (DRX) parameters, semi-persistent scheduling (SPS) parameters, configured grant (CG) parameters, or logical channel prioritization (LCP) parameters. Means for performing operations of block 1104 may include the one or more processors 210, 212, 214, 216, 218, 252, and 260, the wireless transceiver 266, and the communication manager 1004.

In block 1106, the one or more processors may adjust communications with the RAN element using the one or more UE communication parameters. Means for performing operations of block 1106 may include the one or more processors 210, 212, 214, 216, 218, 252, and 260, the wireless transceiver 266, and the communication manager 1004.

FIG. 11B is a process flow diagram illustrating operations 1100b that may be performed as part of the 1100a for coordinating rate adaptation according to various aspects and aspects. With reference to FIGS. 1-11B, the operations 1100b may be performed by a processor (such as the one or more processors 210, 212, 214, 216, 218, 252, 260, 274a) of a UE (such as the UE 120a-120e, 192, 200, 320, 1000a).

After the one or more processors receives from the RAN element a configuration message that configures one or more UE communication parameters to support the change in the bit rate or frame rate of the data flow in block 1104 as described, the one or more processors may transmit to the RAN element a confirmation of receipt of the configuration message in block 1108. Means for performing operations of block 1108 may include the one or more processors 210, 212, 214, 216, 218, 252, and 260, the wireless transceiver 266, and the communication manager 1004.

In block 1110, the one or more processors may adjust communications with the RAN element using the one or more UE communication parameters after a time interval following the transmission of the confirmation to the RAN element. Means for performing operations of block 1110 may include the one or more processors 210, 212, 214, 216, 218, 252, and 260, the wireless transceiver 266, and the communication manager 1004.

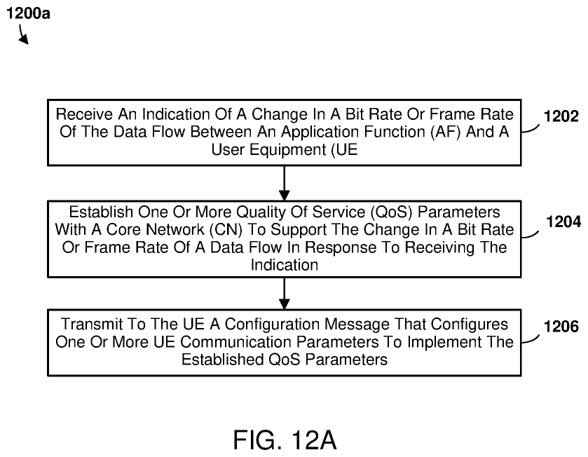

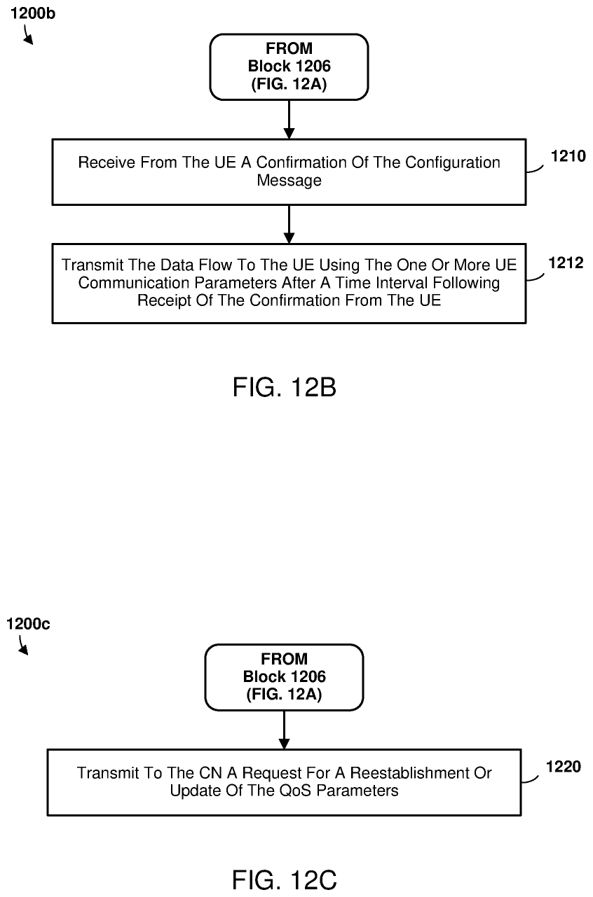

FIG. 12A is a process flow diagram illustrating a method 1200a for coordinating rate adaptation according to various aspects and aspects. With reference to FIGS. 1-12A, the operations of the method 1200a may be performed by a processor (such as the one or more processors 210, 212, 214, 216, 218, 252, 260, 274a) of a RAN element (e.g., 110a-110d, 162, 170, 172, 174, 191, 200, 350, 1000b).

In block 1202, the one or more processors may receive an indication of a change in a bit rate or frame rate of the data flow between an AF and a UE. In some aspects, the one or more processors may receive the indication of the change in the bit rate or frame rate of the data flow from the UE. In some aspects, the one or more processors may receive the indication of the change in the bit rate or frame rate of the data flow from the AF within the CN. Means for performing operations of block 1202 may include the one or more processors 210, 212, 214, 216, 218, 252, and 260, the wireless transceiver 266, and the communication manager 1022.

In block 1204, the one or more processors may negotiate one or more QoS parameters with a CN element to support the change in a bit rate or frame rate of a data flow in response to receiving the indication. In some aspects, the one or more processors may receive from the CN element a reference parameter of one of a plurality of Alternative QoS Profiles (AQPs) that were previously negotiated with the CN element for a protocol data unit (PDU) set supporting the data flow. In some aspects, the one or more processors may negotiate the plurality of AQPs with the CN element as part of establishing the data flow to the UE. In such aspects, each of the AQPs may be associated with a reference parameter and may support a particular bit rate or frame rate for a communication link between the RAN and the UE suitable for supporting the data flow. Means for performing operations of block 1204 may include the one or more processors 210, 212, 214, 216, 218, 252, and 260, the wireless transceiver 266, and the communication manager 1022.

In block 1206, the one or more processors may transmit to the UE a configuration message that configures one or more UE communication parameters to implement the negotiated QoS parameters. In some aspects, the one or more UE communication parameters may include one or more of DRX parameters, SPS parameters, CG parameters, or LCP parameters. Means for performing operations of block 1206 may include the one or more processors 210, 212, 214, 216, 218, 252, and 260, the wireless transceiver 266, and the communication manager 1022.

FIG. 12B is a process flow diagram illustrating operations 1200b that may be performed as part of the 1200a for coordinating rate adaptation according to various aspects and aspects. With reference to FIGS. 1-12B, the operations 1200b may be performed by a processor (such as the one or more processors 210, 212, 214, 216, 218, 252, 260, 274a) of a RAN element (e.g., 110a-110d, 162, 170, 172, 174, 191, 200, 350, 1000b).

After the one or more processors transmits to the UE a configuration message that configures one or more UE communication parameters to implement the negotiated QoS parameters in block 1206 as described, the one or more processors may receive from the UE a confirmation of the configuration message in block 1210. Means for performing operations of block 1210 may include the one or more processors 210, 212, 214, 216, 218, 252, and 260, the wireless transceiver 266, and the communication manager 1022.

In block 1212, the one or more processors may transmit the data flow to the UE using the one or more UE communication parameters after a time interval following receipt of the confirmation from the UE. Means for performing operations of block 1210 may include the one or more processors 210, 212, 214, 216, 218, 252, and 260, the wireless transceiver 266, and the communication manager 1022.

FIG. 12C is a process flow diagram illustrating operations 1200c that may be performed as part of the 1200a for coordinating rate adaptation according to various aspects and aspects. With reference to FIGS. 1-12C, the operations 1200c may be performed by a processor (such as the one or more processors 210, 212, 214, 216, 218, 252, 260, 274a) of a RAN element (e.g., 110a-110d, 162, 170, 172, 174, 191, 200, 350, 1000b).

After the one or more processors transmits to the UE a configuration message that configures one or more UE communication parameters to implement the negotiated QoS parameters in block 1206 as described, the one or more processors may transmit to the CN element a request for a reestablishment or update of the QoS parameters. Means for performing operations of block 1220 may include the one or more processors 210, 212, 214, 216, 218, 252, and 260, the wireless transceiver 266, and the communication manager 1022.

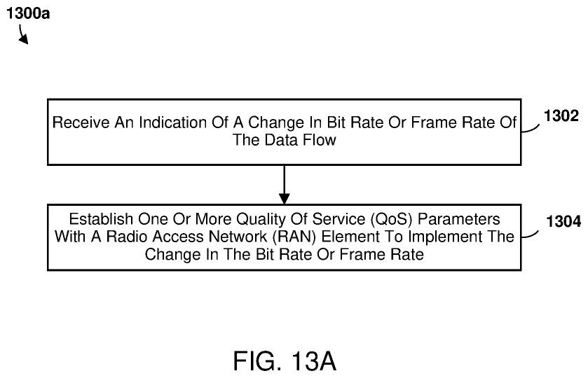

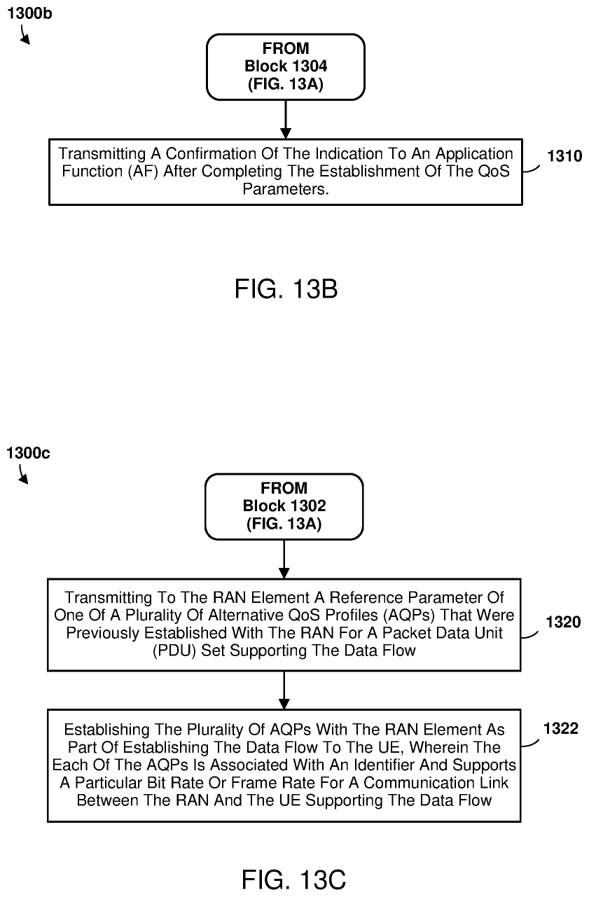

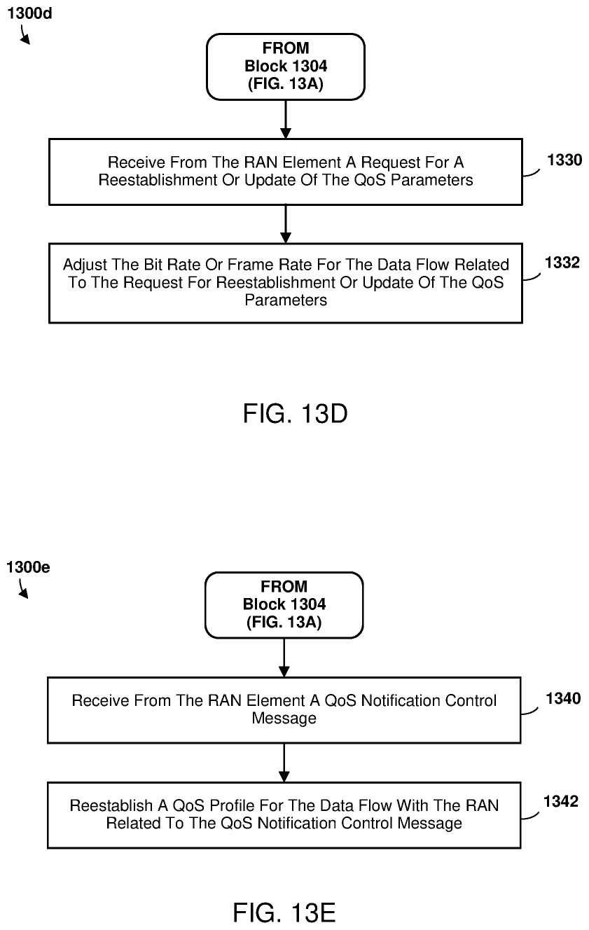

FIG. 13A is a process flow diagram illustrating a method 1300a for coordinating rate adaptation according to various aspects. With reference to FIGS. 1-13A, the operations of the method 1300a may be performed by a processor (such as the one or more processors 210, 212, 214, 216, 218, 252, 260, 274a) of a CN element (e.g., 140, 180, 186, 187, 188, 189, 190, 200, 1000c).

In block 1302, the one or more processors may receive an indication of a change in a bit rate or frame rate of a data flow. In some aspects, the one or more processors may receive the indication of the change in the bit rate or frame rate of the data flow from the UE. In some aspects, the one or more processors may receive the indication of the change in the bit rate or frame rate of the data flow from an AF. Means for performing operations of block 1302 may include the one or more processors 210, 212, 214, 216, 218, 252, and 260, the wireless transceiver 266, and the communication manager 1042.

In block 1304, the one or more processors may negotiate one or more Quality of Service (QoS) parameters with a Radio Access Network (RAN) element to implement the change in the bit rate or frame rate. Means for performing operations of block 1304 may include the one or more processors 210, 212, 214, 216, 218, 252, and 260, the wireless transceiver 266, and the communication manager 1042.

FIG. 13B is a process flow diagram illustrating operations 1300b that may be performed as part of the 1300a for coordinating rate adaptation according to various aspects. With reference to FIGS. 1-13B, the operations 1300b may be performed by a processor (such as the one or more processors 210, 212, 214, 216, 218, 252, 260, 274a) of a CN element (e.g., 140, 180, 186, 187, 188, 189, 190, 200, 1000c).

After the one or more processors negotiates QoS parameters with the RAN element to implement the change in the bit rate or frame rate in block 1304 as described, the one or more processors may transmit a confirmation of the indication to an AF after completing the negotiation of the QoS parameters. Means for performing operations of block 1310 may include the one or more processors 210, 212, 214, 216, 218, 252, and 260, the wireless transceiver 266, and the communication manager 1042.

FIG. 13C is a process flow diagram illustrating operations 1300c that may be performed as part of the 1300a for coordinating rate adaptation according to various aspects. With reference to FIGS. 1-13C, the operations 1300c may be performed by a processor (such as the one or more processors 210, 212, 214, 216, 218, 252, 260, 274a) of a CN element (e.g., 140, 180, 186, 187, 188, 189, 190, 200, 1000c).

After the one or more processors receives an indication of a change in a bit rate or frame rate of a data flow in block 1302 as described, the one or more processors may transmit to the RAN element a reference parameter of one of a plurality of Alternative QoS Profiles (AQPs) that were previously negotiated with the RAN for a protocol data unit (PDU) set supporting the data flow in block 1320. Means for performing operations of block 1320 may include the one or more processors 210, 212, 214, 216, 218, 252, and 260, the wireless transceiver 266, and the communication manager 1042.

In block 1322, the one or more processors may negotiate the plurality of AQPs with the RAN element as part of establishing the data flow to the UE. In some aspects, each of the AQPs is associated with an identifier and supports a particular bit rate or frame rate for a communication link between the RAN and the UE supporting the data flow. Means for performing operations of block 1322 may include the one or more processors 210, 212, 214, 216, 218, 252, and 260, the wireless transceiver 266, and the communication manager 1042.

FIG. 13D is a process flow diagram illustrating operations 1300d that may be performed as part of the 1300a for coordinating rate adaptation according to various aspects. With reference to FIGS. 1-13D, the operations 1300d may be performed by a processor (such as the one or more processors 210, 212, 214, 216, 218, 252, 260, 274a) of a CN element (e.g., 140, 180, 186, 187, 188, 189, 190, 200, 1000c).

After the one or more processors negotiates QoS parameters with the RAN element to implement the change in the bit rate or frame rate in block 1304 as described, the one or more processors may receive from the RAN element a request for a reestablishment or update of the QoS parameters in block 1330. Means for performing operations of block 1330 may include the one or more processors 210, 212, 214, 216, 218, 252, and 260, the wireless transceiver 266, and the communication manager 1042.

In block 1332, the one or more processors may adjust the bit rate or frame rate for the data flow related to the request for reestablishment or update of the QoS parameters. Means for performing operations of block 1332 may include the one or more processors 210, 212, 214, 216, 218, 252, and 260, the wireless transceiver 266, and the communication manager 1042.

FIG. 13E is a process flow diagram illustrating operations 1300e that may be performed as part of the 1300a for coordinating rate adaptation according to various aspects. With reference to FIGS. 1-13E, the operations 1300e may be performed by a processor (such as the one or more processors 210, 212, 214, 216, 218, 252, 260, 274a) of a CN element (e.g., 140, 180, 186, 187, 188, 189, 190, 200, 1000c).

After the one or more processors negotiates QoS parameters with the RAN element to implement the change in the bit rate or frame rate in block 1304 as described, the one or more processors may receive from the RAN element a QoS notification control message in block 1340. Means for performing operations of block 1340 may include the one or more processors 210, 212, 214, 216, 218, 252, and 260, the wireless transceiver 266, and the communication manager 1042.

In block 1342, the one or more processors may renegotiate a QoS profile for the data flow with the RAN related to the QoS notification control message. Means for performing operations of block 1340 may include the one or more processors 210, 212, 214, 216, 218, 252, and 260, the wireless transceiver 266, and the communication manager 1042.

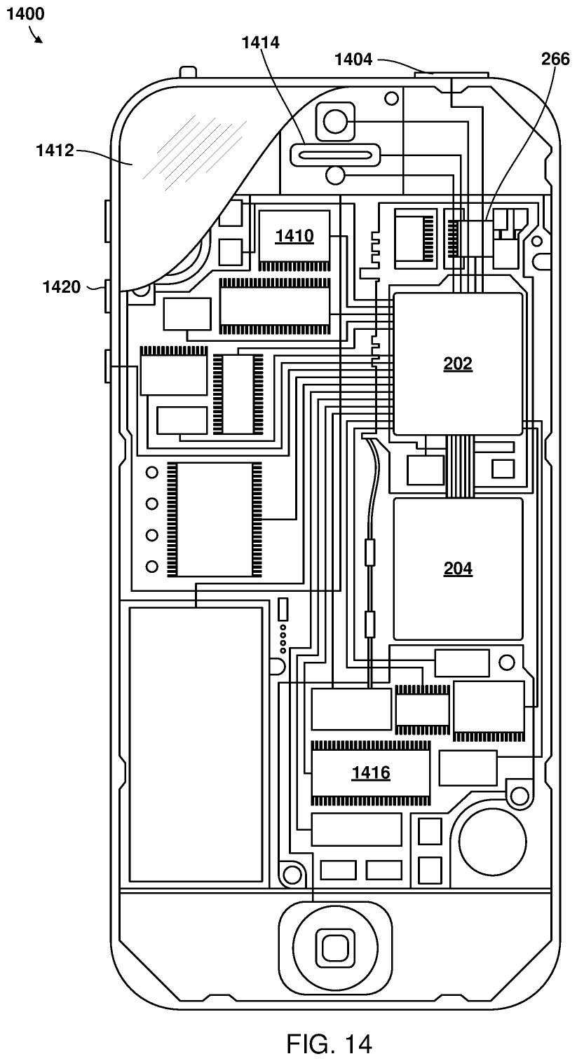

FIG. 14 is a component block diagram of a UE 1400 suitable for use with various aspects. With reference to FIGS. 1A-14, various aspects may be implemented on a variety of UEs 1400 (for example, the UEs 120a-120e, 200, 320, 400a), an example of which is illustrated in FIG. 14 in the form of a smartphone. The UE 1400 may include a first SOC 202 (for example, a SOC-CPU) coupled to a second SOC 204 (for example, a 5G capable SOC). The first and second SOCs 202, 204 may be coupled to internal memory 1416, a display 1412, and to a speaker 1414. Additionally, the UE 1400 may include an antenna 1404 for sending and receiving electromagnetic radiation that may be connected to a wireless transceiver 266 coupled to one or more processors in the first and/or second SOCs 202, 204. The UE 1400 may include menu selection buttons or rocker switches 1420 for receiving user inputs. The UE 1400 may include a sound encoding/decoding (CODEC) circuit 1410, which digitizes sound received from a microphone into data packets suitable for wireless transmission and decodes received sound data packets to generate analog signals that are provided to the speaker to generate sound. One or more of the one or more processors in the first and second SOCs 202, 204, wireless transceiver 266 and CODEC 1410 may include a digital signal processor (DSP) circuit (not shown separately).

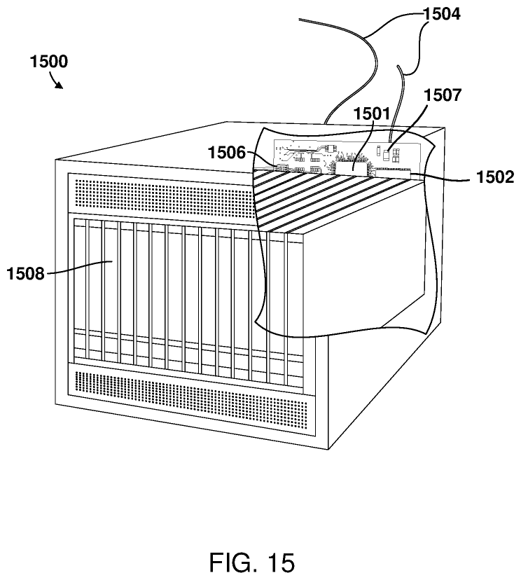

FIG. 15 is a component block diagram of a network device 1500 suitable for use with various aspects. Such network devices (e.g., AF 185, 400a, 508, PCF 188, 400b, 506, SMF 189, 400c, 504, RAN elements 110a-110d, 162, 170, 172, 174, 191, 200, 350, 400d, 502, and other CN elements) may include at least the components illustrated in FIG. 15. With reference to FIGS. 1A-15, the network device 1500 may typically include a processor 1501 coupled to volatile memory 1502 and a large capacity nonvolatile memory, such as a disk drive 1508. The network device 1500 also may include a peripheral memory access device 1506 such as a floppy disc drive, compact disc (CD) or digital video disc (DVD) drive coupled to the one or more processors 1501. The network device 1500 also may include network access ports 1504 (or interfaces) coupled to the one or more processors 1501 for establishing data connections with a network, such as the Internet or a local area network coupled to other system computers and servers. The network device 1500 may include one or more antennas 1507 for sending and receiving electromagnetic radiation that may be connected to a wireless communication link. The network device 1500 may include additional access ports, such as USB, Firewire, Thunderbolt, and the like for coupling to peripherals, external memory, or other devices.

The one or more processors of the UE 1400 and the network device 1500 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the one or more memories 1416, 1502 before they are accessed and loaded into the processor. The one or more processors may include internal memory sufficient to store the application software instructions.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the methods and operations disclosed herein may be substituted for or combined with one or more operations of the methods and operations disclosed herein.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various aspects. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Implementation examples are described in the following paragraphs. While some of the following implementation examples are described in terms of example methods, further example implementations may include: the example methods discussed in the following paragraphs implemented by an AF, CN element, or RAN element including a processor configured with processor-executable instructions to perform operations of the methods of the following implementation examples; the example methods discussed in the following paragraphs implemented by an AF, CN element, or RAN element including means for performing functions of the methods of the following implementation examples; and the example methods discussed in the following paragraphs may be implemented as a non-transitory processor-readable storage medium having stored thereon processor-executable instructions configured to cause a processor of an AF, CN element, or RAN element to perform the operations of the methods of the following implementation examples.
Example 1. A method performed at an application function (AF), including: transmitting, to a core network (CN) element, Alternative Service Requirements for Protocol Data Unit (PDU) Sets supporting data traffic of an application, in which the Alternative Service Requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt.
Example 2. The method of example 1, in which different Alternative Service Requirements for PDU Sets include different combinations of PSDB, PSER, and GFBR values to which the application can adapt.
Example 3. The method of either of examples 1 or 2, in which the different combinations of PSDB, PSER, and GFBR values are in a prioritized order in each of the Alternative Service Requirements.
Example 4. The method of any of examples 1-3, in which the QoS reference parameters include a bit rate, a delay budget, and an error rate applicable to PDU Sets.
Example 5. The method of any of examples 1-4, further including: receiving from the CN element an indication that a communication link between a Radio Access Network (RAN) element and a user equipment (UE) can no longer guarantee the GFBR for a QoS Flow transporting PDU Sets, in which the indication includes an identification of one of the QoS reference parameters corresponding to one of a plurality of Alternative QoS Parameters Sets; determining PSDB, PSER, and GFBR values for PDU Sets based on the identified QoS reference parameter; and updating codec settings for PDU Set based traffic based on the determined PSDB, PSER, and GFBR values.
Example 6. A method performed at a first core network (CN) element, including: receiving, from an Application Function (AF), Alternative Service Requirements for Protocol Data Unit (PDU) Sets supporting data traffic of an application, in which each of the Alternative Service Requirements for PDU Sets include one or more QoS reference parameters and a combination of a PDU Set Delay Budget (PSDB) value, a PDU Set Error Rate (PSER) value, and a Guaranteed Flow Bit Rate (GFBR) value to which the application can adapt; transmitting to a second CN element Policy and Charging Control (PCC) rules based on a plurality of Alternative QoS parameter sets derived from the one or more QoS reference parameters of the Alternative Service Requirements for PDU Sets; receiving from said second CN element an indication that a communication link between a Radio Access Network (RAN) element and a user equipment (UE) can no longer guarantee a current GFBR for a QoS Flow transporting PDU Sets, in which the indication includes a reference to one of a plurality of Alternative QoS Profiles (AQPs) that identifies a PSDB value, a PSER value, and a GFBR value to which the application can adapt; and transmitting to the AF a notification that the communication link between the RAN element and the UE can no longer guarantee the GFBR for the QoS Flow transporting PDU Sets, in which the notification includes an identification of one of the QoS reference parameters of the Alternative Service Requirements for PDU Sets that can be supported.
Example 7. The method of example 6, in which the first CN entity includes a Policy Control Function (PCF) and the second CN entity includes a Session Management Function (SMF).
Example 8. The method of either of examples 6 or 7, in which the first CN entity and the second CN entity are the same entities or co-located entities.
Example 9. A method performed by a first core network (CN) element including: receiving, from a second CN element, Policy and Charging Control (PCC) rules for data traffic supporting an application that is based on QoS requirements for PDU Sets and a plurality of Alternative QoS parameter sets including a PDU Set Delay Budget (PSDB) value and a PDU Set Error Rate (PSER) value; establishing a QoS Flow transporting PDU Sets for data traffic supporting the application with a Radio Access Network (RAN) element, including transmitting to the RAN element a QoS profile for the QoS Flow transporting PDU Sets and one of a plurality of Alternative QoS Profiles (AQPs) derived from the plurality of Alternative QoS parameter sets; receiving from the RAN element an indication that a communication link with a user equipment (UE) can no longer guarantee a Guaranteed Flow Bit Rate (GFBR) for the QoS Flow transporting PDU Sets, in which the indication includes a reference to one of the plurality of AQPs that identifies a PDU Set Delay Budget (PSDB) value, a PDU Set Error Rate (PSER) value, and a GFBR value that the RAN element can support and to which the application can adapt; and transmitting to the second CN element a notification that the communication link with the UE can no longer guarantee the GFBR for the QoS Flow transporting PDU Sets, in which the notification includes a reference to one of the Alternative QoS parameter sets associated with the AQP that the RAN element can support.
Example 10. The method of example 9, further including: receiving from the RAN element an indication that the communication link with the UE can guarantee again the GFBR for PDU Sets session for application data traffic being communicated between the RAN element and the UE; and transmitting to the second CN element a notification that the communication link with the UE can guarantee again the GFBR for the QoS Flow transporting PDU Sets in a PDU session for application data traffic being communicated between the RAN element and the UE.
Example 11. The method of either of examples 9 or 10, in which the first CN entity includes a Session Management Function (SMF) and the second CN entity includes a Policy Control Function (PCF).
Example 12. The method of claim 9, in which the first CN entity and the second CN entity are the same entities or co-located entities.
Example 13. A method performed at a Radio Access Network (RAN) element, including: receiving from a core network (CN) element Alternative quality of service (QoS) Profiles (AQPs) for Protocol Data Unit (PDU) Sets; determining that a communication link with a user equipment (UE) can no longer guarantee a quality of service (QoS) profile for a current QoS Flow transporting PDU Sets; determining that at least one of the AQPs for PDU Sets can be supported by checking whether a Guaranteed Flow Bit Rate (GFBR) value, PDU Set Delay Budget (PSDB) value, and a PDU Set Error Rate (PSER) value can be supported by the RAN element; and transmitting to the CN element an indication that the communication link with the UE can no longer guarantee the QoS profile for the current QoS Flow transporting PDU Sets, in which the indication includes a reference parameter for one of a plurality of AQPs that includes a PSDB value, a PSER value, and a GFBR value to which the application can add adapt.
Example 14. The method of example 13, further including: determining that the communication link with the UE can guarantee again the QoS profile for the QoS Flow transporting PDU Sets, and transmitting to the CN element an indication that the communication link with the UE can guarantee again the QoS profile for the QoS Flow transporting PDU Sets.
Example 15. A method performed at a user equipment (UE) for wireless communication, including: transmitting to a Radio Access Network (RAN) element an indication of a change in a bit rate or frame rate of a data flow for an application client (AC) executing on the UE; receiving from the RAN element a configuration message that configures one or more UE communication parameters to support the change in the bit rate or frame rate of the data flow; and adjusting communications with the RAN element using the one or more UE communication parameters.
Example 16. The method of example 15, in which transmitting to the RAN element the indication of the change in the bit rate or frame rate of the data flow includes transmitting the indication of the change in the bit rate or frame rate of the data flow via radio resource control (RRC) signaling or a medium access control-control element (MAC CE).
Example 17. The method of either of examples 15 or 16, in which transmitting to the RAN element the indication of the change in the bit rate or frame rate of the data flow includes transmitting an indication of a specified bit rate or frame rate of the data flow.
Example 18. The method of any of examples 1-17, further including transmitting to the RAN element a confirmation of receipt of the configuration message, in which adjusting communications with the RAN element using the one or more UE communication parameters includes adjusting communications with the RAN element using the one or more UE communication parameters after a time interval following the transmission of the confirmation of receipt of the configuration message to the RAN element.
Example 19. The method of any of examples 1-18, in which the one or more UE communication parameters received from the RAN element comprise one or more of discontinuous reception (DRX) parameters, semi-persistent scheduling (SPS) parameters, configured grant (CG) parameters, or logical channel prioritization (LCP) parameters.
Example 20. A method performed at a Radio Access Network (RAN) element for wireless communication, including: receiving an indication of a change in a bit rate or frame rate of a data flow between an application function (AF) and a user equipment (UE); establishing one or more Quality of Service (QoS) parameters with a core network (CN) element to support the change in a bit rate or frame rate of the data flow in response to receiving the indication; and transmitting to the UE a configuration message that configures one or more UE communication parameters to implement the established QoS parameters.
Example 21. The method of example 22, in which receiving an indication of the change in the bit rate or frame rate of the data flow includes receiving the indication from the UE.
Example 23. The method of any of examples 22, in which receiving an indication of the change in the bit rate or frame rate of the data flow includes receiving the indication from the AF via the CN element.
Example 24. The method of either of examples 21 or 23, further including: receiving from the UE a confirmation of the configuration message; and transmitting the data flow to the UE using the one or more UE communication parameters after a time interval following receipt of the confirmation from the UE.
Example 25. The method of example 24, in which transmitting the application data flow to the UE using the one or more UE communication parameters after a time interval following receipt of the confirmation from the UE includes: transmitting the application data flow to the UE using the one or more UE communication parameters after a time interval following receipt of the confirmation from the UE.
Example 26. The method of any of examples 20-25, in which the one or more UE communication parameters comprise one or more of discontinuous reception (DRX) parameters, semi-persistent scheduling (SPS) parameters, configured grant (CG) parameters, or logical channel prioritization (LCP) parameters.
Example 27. The method of any of examples 20-26, in which establishing QoS parameters with the CN element includes receiving from the CN element a reference parameter of one of a plurality of Alternative QoS Profiles (AQPs) that were previously established with the CN element for a protocol data unit (PDU) set supporting the data flow.
Example 28. The method of any of examples 20-27, further including establishing the plurality of AQPs with the CN element as part of establishing the data flow to the UE, in which each of the AQPs is associated with a reference parameter and supports a particular bit rate or frame rate for a communication link between the RAN and the UE suitable for supporting the data flow.
Example 29. The method of any of examples 20-13, further including transmitting to the CN element a request for a reestablishment or update of the QoS parameters.
Example 30. A method performed at a core network (CN) element for supporting wireless communications, including: receiving an indication of a change in a bit rate or frame rate of a data flow; and establishing one or more Quality of Service (QoS) parameters with a Radio Access Network (RAN) element to implement the change in the bit rate or frame rate.
Example 31. The method of example 30, in which receiving an indication of the change in bit rate or frame rate of the data flow includes receiving an indication of the change in the bit rate or frame rate of the data flow from the UE.
Example 32. The method of either of examples 30 or 31, in which receiving an indication of the change in bit rate or frame rate of the data flow includes receiving an indication of the change in the bit rate or frame rate of the data flow from an application function (AF).
Example 33. The method of any of examples 30-32, further including transmitting a confirmation of the indication to an application function (AF) after completing the establishment of the one or more QoS parameters.
Example 34. The method of any of examples 30-33, in which establishing QoS parameters with the RAN element includes transmitting to the RAN element a reference parameter of one of a plurality of Alternative QoS Profiles (AQPs) that were previously establishing with the RAN for a protocol data unit (PDU) set supporting the data flow.
Example 35. The method of any of examples 30-34, further including establishing the plurality of AQPs with the RAN element as part of establishing the data flow to the UE, in which each of the AQPs is associated with an identifier and supports a particular bit rate or frame rate for a communication link between the RAN and the UE supporting the data flow.
Example 36. The method of any of examples 30-35, further including: receiving from the RAN element a request for a reestablishment or update of the QoS parameters; and adjusting the bit rate or frame rate for the data flow related to the request for reestablishment or update of the QoS parameters.
Example 37. The method of any of examples 30-36, further including: receiving from the RAN element a QoS notification control message; and reestablishing a QoS profile for the data flow with the RAN related to the QoS notification control message.
Example 38. An apparatus for wireless communication at a first network element, including: one or more memories; and one or more processors coupled to the one or more memories and configured, individually or collectively, to cause the first network element to: provide to a second network element Alternative Service Requirements r Protocol Data Unit (PDU) Sets supporting data traffic of an application, wherein the Alternative Service Requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt. Additionally or alternatively, the Alternative QoS Profile represents a combination of QoS parameters that the application executing on the UE can accept or adapt to. Additionally or alternatively, the Alternative Service Requirements or Alternative QoS Profiles represent combinations of QoS parameters that include a PDB to which the application is able to adapt, a PER to which the application is able to adapt, a GFBR to which the application is able to adapt, a MDBV to which the application is able to adapt, and/or combinations of these parameters.
Example 39. The apparatus of example 38, wherein the one or more processors are further configured, individually or collectively, to cause the first network element to adapt one or more parameters for PDU Set based traffic based on information received from the second network element that the second network element will send if the second network element cannot support a default QoS. Additionally or alternatively, if the second network element is unable support the QoS parameters of a current data flow, the second network element will inform the first network element of this condition by sending a message that includes information regarding the condition, and the one or more processors will be configured, individually or collectively, to cause the first network element to use that information to configure or adapt QoS parameters for the PDU Set to support further communications. In some aspects, the one or more parameters may be parameters specified in one or more of the Alternative Service Requirements or Alternative QoS Profiles.
Example 40. The apparatus of either of examples 38 or 39, wherein different ones of the Alternative Service Requirements for PDU Sets include different combinations of PSDB, PSER, and GFBR values to which the application can adapt.
Example 41. The apparatus of example 38, wherein the different combinations of PSDB, PSER, and GFBR values are in a prioritized order in each of the Alternative Service Requirements.
Example 42. The apparatus of any of examples 38-41, wherein to adapt one or more parameters for PDU Set based traffic based on information received in response from the second network element, the one or more processors are further configured, individually or collectively, to cause the first network entity to: receive from the second network element an indication that a communication link between a third network element and a user equipment (UE) can no longer guarantee the GFBR for the QoS Flow transporting PDU Sets, wherein the indication includes an identification of one of the QoS reference parameters corresponding to one of a plurality of Alternative QoS Parameters Sets or Alternative Service Requirements; determine PSDB, PSER, and GFBR values for PDU Sets based on the identified QoS reference parameter; and update codec settings for PDU Set based traffic based on the determined PSDB, PSER, and GFBR values.
Example 43. The apparatus of any of examples 38-42, wherein: the second network element is a core network element; and the indication that a communication link between a third network element and a user equipment (UE) can no longer guarantee the GFBR for the QoS Flow transporting PDU Sets is received from the core network as an indication that the communication link between a Radio Access Network (RAN) and the UE longer supports the GFBR for the QoS Flow transporting PDU Sets.
Example 44. An apparatus for wireless communication at a first network element, including: one or more memories; and one or more processors coupled to the one or more memories and configured, individually or collectively, to cause the first network element to: obtain a Quality of Service (QoS) profile for a QoS Flow transporting Protocol Data Unit (PDU) Sets and one of a plurality of Alternative Service Requirements for PDU Sets supporting data traffic of an application, wherein each of the Alternative Service Requirements for PDU Sets include one or more QoS reference parameters and a combination of a PDU Set Delay Budget (PSDB) value, a PDU Set Error Rate (PSER) value, and a Guaranteed Flow Bit Rate (GFBR) value to which the application can adapt; provide Policy and Charging Control (PCC) rules based on a plurality of Alternative QoS parameter sets derived from the one or more QoS reference parameters of the Alternative Service Requirements for PDU Sets; receive an indication that a communication link between a second network element and a user equipment (UE) can no longer guarantee a current GFBR for a QoS Flow transporting PDU Sets, wherein the indication includes a reference to one of a plurality of Alternative QoS Profiles (AQPs) that identifies a PSDB value, a PSER value, and a GFBR value to which the application can adapt; and provide a notification that the communication link between the second element and the UE can no longer guarantee the GFBR for the QoS Flow transporting PDU Sets, wherein the notification includes an identification of one of the QoS reference parameters of the Alternative Service Requirements for PDU Sets that can be supported.
Example 45. The apparatus of example 44, wherein the one or more processors are further configured, individually or collectively, to cause the first network element to: determine that the communication link with the UE can guarantee again the QoS profile for the QoS Flow transporting PDU Sets; and provide an indication that the communication link with the UE can guarantee the QoS profile for the QoS Flow transporting PDU Sets.
Example 46. The apparatus of either of examples 44 or 45, wherein: the first network element includes a Policy Control Function (PCF) network element; the Alternative Service Requirements for PDU Sets supporting data traffic of the application are obtained from an Application Function (AF) network element; the PCC rules are provided to a Session Management Function (SMF) network element; the indication that a communication link between a second network element and a user equipment (UE) can no longer guarantee a current GFBR for a QoS Flow transporting PDU Sets is received from the SMF network element; and the notification that the communication link between the second element and the UE can no longer guarantee the GFBR for the QoS Flow transporting PDU Sets is provided to the AF network element.
Example 47. An apparatus for wireless communication at a first network element including: one or more memories; and one or more processors coupled to the one or more memories and configured, individually or collectively, to cause the first network element to: obtain Policy and Charging Control (PCC) rules for data traffic supporting an application that is based on QoS requirements for PDU Sets and a plurality of Alternative QoS parameter sets including a PDU Set Delay Budget (PSDB) value and a PDU Set Error Rate (PSER) value; establish a QoS Flow for transporting PDU Sets for data traffic supporting the application with a second network element, wherein to establish the QoS flow the one or more processor are configured, individually or collectively, to cause the first network entity to provide to the second network element a QoS profile for the QoS Flow transporting PDU Sets and one of a plurality of Alternative QoS Profiles (AQPs) derived from the plurality of Alternative QoS parameter sets; receive from the second network element an indication that a communication link with a user equipment (UE) can no longer guarantee a Guaranteed Flow Bit Rate (GFBR) for the QoS Flow transporting PDU Sets, wherein the indication includes a reference to one of the plurality of AQPs that identifies a PDU Set Delay Budget (PSDB) value, a PDU Set Error Rate (PSER) value, and a GFBR value that the second network element can support and to which the application can adapt; and provide a notification that the communication link with the UE can no longer guarantee the GFBR for the QoS Flow transporting PDU Sets, wherein the notification includes a reference to one of the Alternative QoS parameter sets associated with the AQP that the second network element can support.
Example 48. The apparatus of example 47, wherein different ones of the Alternative QoS Profiles for PDU Sets include different combinations of PSDB, PSER, and GFBR.
Example 49. The apparatus of example 47, wherein different ones of the Alternative QoS Profiles for PDU Sets include different combinations of PSDB, PSER, GFBR, and a maximum data burst volume (MDBV).
Example 50. The apparatus of any of examples 47-49, wherein the one or more processors are further configured, individually or collectively, to cause the first network element to: receive from the second network element an indication that the communication link with the UE can guarantee the GFBR for PDU Sets session for application data traffic being communicated between the second network element and the UE; and provide a notification that the communication link with the UE can guarantee the GFBR for the QoS Flow transporting PDU Sets in a PDU session for application data traffic being communicated between the second element and the UE.
Example 51. The apparatus of any of examples 47-50, wherein: the first network element is a Session Management Function (SMF) network element; PCC rules for data traffic supporting the application are received from a Policy Control Function (PCF) network element; the second network element is a Radio Access Network element; the notification that the communication link with the UE can no longer guarantee the GFBR for the QoS Flow transporting PDU Sets is transmitted to the PCF network element; and the notification that the communication link with the UE can guarantee again the GFBR for the QoS Flow transporting PDU Sets in a PDU session for application data traffic being communicated between the second element and the UE is transmitted to the PCF network element.
Example 52. An apparatus for wireless communication at a first network element, including: one or more memories; and one or more processors coupled to the one or more memories and configured, individually or collectively, to cause the first network element to: obtain from a second network element Alternative quality of service (QoS) Profiles (AQPs) for Protocol Data Unit (PDU) Sets; determine that a communication link with a user equipment (UE) can no longer guarantee a quality of service (QoS) profile for a current QoS Flow transporting PDU Sets; determine that at least one of the AQPs for PDU Sets can be supported by checking whether a Guaranteed Flow Bit Rate (GFBR) value, PDU Set Delay Budget (PSDB) value, and a PDU Set Error Rate (PSER) value can be supported by the first network element; and provide to the second network element an indication that the communication link with the UE can no longer guarantee the QoS profile for the current QoS Flow transporting PDU Sets, wherein the indication includes a reference parameter for one of a plurality of AQPs that includes a PSDB value, a PSER value, and a GFBR value to which an application can add adapt.
Example 53. The apparatus of example 52, wherein different ones of the Alternative QoS Profiles for PDU Sets include different combinations of PSDB, PSER, and GFBR.
Example 54. The apparatus of either of examples 52 or 53, wherein different ones of the Alternative QoS Profiles for PDU Sets include different combinations of PSDB, PSER, GFBR, and a maximum data burst volume (MDBV).
Example 55. The apparatus of any of examples 52-54, wherein the one or more processors are further configured, individually or collectively, to cause the first network element to: determine that the communication link with the UE can guarantee the QoS profile for the QoS Flow transporting PDU Sets; and provide to the second network element an indication that the communication link with the UE can guarantee the QoS profile for the QoS Flow transporting PDU Sets.
Example 56. The apparatus of any of examples 52-55, wherein: the first network element is a Radio Access Network; and the second network element is a core network element.
Example 57. An apparatus for wireless communication at a first network element, including: one or more memories; and one or more processors couple to the memory and configured, individually or collectively, to cause the first network element to: receive an indication of a change in a bit rate or frame rate of a data flow between a second network element and a user equipment (UE); establish one or more Quality of Service (QoS) parameters with a third network element to support the change in a bit rate or frame rate of the data flow in response to receiving the indication; and provide to the UE a configuration message that configures one or more UE communication parameters to implement the established QoS parameters.
Example 58. The apparatus of example 57, wherein to establish QoS parameters with the third network element the one or more processors are further configured, individually or collectively, to receive from the third network element a reference parameter of one of a plurality of Alternative QoS Profiles (AQPs) that were previously established with the third network element for a protocol data unit (PDU) set supporting the data flow.
Example 59. The apparatus of example 57, wherein the one or more processors are further configured, individually or collectively, to establish the plurality of AQPs with the third network element as part of establishing the data flow to the UE, wherein each of the AQPs is associated with a reference parameter and supports a particular bit rate or frame rate for a communication link between the first network element and the UE suitable for supporting the data flow.
Example 60. The apparatus of any of examples 57-59, wherein the one or more processors are further configured, individually or collectively, to provide to the third network element a request for a reestablishment or update of the QoS parameters.
Example 61. An apparatus for wireless communication at a first network element, including: one or more memories; and one or more processors coupled to the one or more memories and configured, individually or collectively, to cause the first network element to: obtain an indication of a change in a bit rate or frame rate of a data flow; and establish one or more Quality of Service (QoS) parameters with a second network element to implement the change in the bit rate or frame rate.
Example 62. The apparatus of example 61, wherein the one or more processors are further configured, individually or collectively, to establish QoS parameters with the second network element by providing to the second network element a reference parameter of one of a plurality of Alternative QoS Profiles (AQPs) that were previously established with the second network element for a protocol data unit (PDU) set supporting the data flow.
Example 63. The apparatus of either of examples 61 or 62, wherein the one or more processors are further configured, individually or collectively, to establish the plurality of AQPs with the second network element as part of establishing the data flow to the UE, wherein each of the AQPs is associated with an identifier and supports a particular bit rate or frame rate for a communication link between the second network element and the UE supporting the data flow.
Example 64. The apparatus of any of examples 61-63, wherein the one or more processors are further configured, individually or collectively, to cause the first network element to: receive from the second network element a request for a reestablishment or update of the QoS parameters; and adjust the bit rate or frame rate for the data flow related to the request for reestablishment or update of the QoS parameters.
Example 65. An apparatus for wireless communication at a user equipment (UE), comprising: a processing system that includes processor circuitry and memory circuitry that stores code and is coupled with the processor circuitry, the processing system configured to cause the UE to perform the method of one or more of examples 15-19.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the one or more processors may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. An apparatus for wireless communication at a first network element, comprising:
one or more memories; and
one or more processors coupled to the one or more memories and configured to cause the first network element to:
provide to a second network element Alternative Service Requirements for Protocol Data Unit (PDU) Sets supporting data traffic of an application,
wherein the Alternative Service Requirements for PDU Sets include one or more quality of service (QoS) reference parameters and a combination of a PDU Set Delay Budget (PSDB) value, a PDU Set Error Rate (PSER) value, and a Guaranteed Flow Bit Rate (GFBR) value to which the application can adapt.

2. The apparatus of claim 1, wherein the one or more processors are further configured to cause the first network element to adapt one or more parameters for PDU Set based traffic based on information received from the second network element that the second network element will send if the second network element cannot support a default QoS.

3. The apparatus of claim 1, wherein different ones of the Alternative Service Requirements for PDU Sets include different combinations of PSDB, PSER, and GFBR values to which the application can adapt.

4. The apparatus of claim 1, wherein the different combinations of PSDB, PSER, and GFBR values are in a prioritized order in each of the Alternative Service Requirements.

5. The apparatus of claim 1, wherein to adapt one or more parameters for PDU Set based traffic based on information received in response from the second network element, the one or more processors are further configured to cause the first network element to:
receive from the second network element an indication that a communication link between a third network element and a user equipment (UE) can no longer guarantee the GFBR for the QoS Flow transporting PDU Sets, wherein the indication includes an identification of one of the QoS reference parameters corresponding to one of a plurality of Alternative QoS Parameters Sets;
determine PSDB, PSER, and GFBR values for PDU Sets based on the identified QoS reference parameter; and
update codec settings for PDU Set based traffic based on the determined PSDB, PSER, and GFBR values.

6. The apparatus of claim 1, wherein:
the second network element is a core network element; and
the indication that a communication link between a third network element and a user equipment (UE) can no longer guarantee the GFBR for the QoS Flow transporting PDU Sets is received from the core network element as an indication that the communication link between a Radio Access Network (RAN) and the UE longer supports the GFBR for the QoS Flow transporting PDU Sets.

7. An apparatus for wireless communication at a first network element, comprising:
one or more memories; and
one or more processors coupled to the one or more memories and configured to cause the first network element to:
obtain a Quality of Service (QoS) profile for a QoS Flow transporting Protocol Data Unit (PDU) Sets and one of a plurality of Alternative Service Requirements for PDU Sets supporting data traffic of an application, wherein each of the Alternative Service Requirements for PDU Sets include one or more QoS reference parameters and a combination of a PDU Set Delay Budget (PSDB) value, a PDU Set Error Rate (PSER) value, and a Guaranteed Flow Bit Rate (GFBR) value to which the application can adapt;
provide Policy and Charging Control (PCC) rules based on a plurality of Alternative QoS parameter sets derived from the one or more QoS reference parameters of the Alternative Service Requirements for PDU Sets;
receive an indication that a communication link between a second network element and a user equipment (UE) can no longer guarantee a current GFBR for a QoS Flow transporting PDU Sets, wherein the indication includes a reference to one of a plurality of Alternative QoS Profiles that identifies a PSDB value, a PSER value, and a GFBR value to which the application can adapt; and
provide a notification that the communication link between the second element and the UE can no longer guarantee the GFBR for the QoS Flow transporting PDU Sets, wherein the notification includes an identification of one of the QoS reference parameters of the Alternative Service Requirements for PDU Sets that can be supported.

8. The apparatus of claim 7, wherein the one or more processors are further configured to cause the first network element to:
determine that the communication link with the UE can guarantee again the QoS profile for the QoS Flow transporting PDU Sets; and
provide an indication that the communication link with the UE can guarantee the QoS profile for the QoS Flow transporting PDU Sets.

9. The apparatus of claim 7, wherein:
the first network element comprises a Policy Control Function (PCF) network element;
the Alternative Service Requirements for PDU Sets supporting data traffic of the application are obtained from an Application Function (AF) network element;
the PCC rules are provided to a Session Management Function (SMF) network element;
the indication that the communication link between the second network element and the UE can no longer guarantee the current GFBR for a QoS Flow transporting PDU Sets is received from the SMF network element; and
the notification that the communication link between the second element and the UE can no longer guarantee the GFBR for the QoS Flow transporting PDU Sets is provided to the AF network element.

10. An apparatus for wireless communication at a first network element comprising:
one or more memories; and
one or more processors coupled to the one or more memories and configured to cause the first network element to:
obtain Policy and Charging Control (PCC) rules for data traffic supporting an application that is based on QoS requirements for PDU Sets and a plurality of Alternative QoS parameter sets including a PDU Set Delay Budget (PSDB) value and a PDU Set Error Rate (PSER) value;
establish a QoS Flow for transporting PDU Sets for data traffic supporting the application with a second network element, wherein to establish the QoS flow, the one or more processor are configured to cause the first network element to provide to the second network element a QoS profile for the QoS Flow transporting PDU Sets and one of a plurality of Alternative QoS Profiles derived from the plurality of Alternative QoS parameter sets;
receive from the second network element an indication that a communication link with a user equipment (UE) can no longer guarantee a Guaranteed Flow Bit Rate (GFBR) for the QoS Flow transporting PDU Sets, wherein the indication includes a reference to one of the plurality of Alternative QoS Profiles that identifies a PDU Set Delay Budget (PSDB) value, a PDU Set Error Rate (PSER) value, and a GFBR value that the second network element can support and to which the application can adapt; and
provide a notification that the communication link with the UE can no longer guarantee the GFBR for the QoS Flow transporting PDU Sets, wherein the notification includes a reference to one of the Alternative QoS parameter sets associated with the AQP that the second network element can support.

11. The apparatus of claim 10, wherein different ones of the plurality of plurality of Alternative QoS Profiles for PDU Sets include different combinations of PSDB, PSER, and GFBR.

12. The apparatus of claim 10, wherein different ones of the plurality of plurality of Alternative QoS Profiles for PDU Sets include different combinations of PSDB, PSER, GFBR, and a maximum data burst volume (MDBV).

13. The apparatus of claim 10, wherein the one or more processors are further configured to cause the first network element to:
receive from the second network element an indication that the communication link with the UE can guarantee the GFBR for PDU Sets session for application data traffic being communicated between the second network element and the UE; and
provide a notification that the communication link with the UE can guarantee the GFBR for the QoS Flow transporting PDU Sets in a PDU session for application data traffic being communicated between the second element and the UE.

14. The apparatus of claim 13, wherein:
the first network element is a Session Management Function (SMF) network element;
PCC rules for data traffic supporting the application are received from a Policy Control Function (PCF) network element;
the second network element is a Radio Access Network element;
the notification that the communication link with the UE can no longer guarantee the GFBR for the QoS Flow transporting PDU Sets is transmitted to the PCF network element; and
the notification that the communication link with the UE can guarantee again the GFBR for the QoS Flow transporting PDU Sets in a PDU session for application data traffic being communicated between the second element and the UE is transmitted to the PCF network element.

15. An apparatus for wireless communication at a first network element, comprising:
one or more memories; and
one or more processors coupled to the one or more memories and configured to cause the first network element to:
obtain from a second network element Alternative quality of service (QoS) Profiles (AQPs) for Protocol Data Unit (PDU) Sets;
determine that a communication link with a user equipment (UE) can no longer guarantee a quality of service (QoS) profile for a current QoS Flow transporting PDU Sets;
determine that at least one of the Alternative QoS Profiles for PDU Sets can be supported by checking whether a Guaranteed Flow Bit Rate (GFBR) value, PDU Set Delay Budget (PSDB) value, and a PDU Set Error Rate (PSER) value can be supported by the first network element; and
provide to the second network element an indication that the communication link with the UE can no longer guarantee the QoS profile for the current QoS Flow transporting PDU Sets, wherein the indication includes a reference parameter for one of a plurality of Alternative QoS Profiles that includes a PSDB value, a PSER value, and a GFBR value to which an application can add adapt.

16. The apparatus of claim 15, wherein different ones of the Alternative QoS Profiles for PDU Sets include different combinations of PSDB, PSER, and GFBR.

17. The apparatus of claim 15, wherein different ones of the Alternative QoS Profiles for PDU Sets include different combinations of PSDB, PSER, GFBR, and a maximum data burst volume (MDBV).

18. The apparatus of claim 15, wherein the one or more processors are further configured to cause the first network element to:
determine that the communication link with the UE can guarantee the QoS profile for the QoS Flow transporting PDU Sets; and
provide to the second network element an indication that the communication link with the UE can guarantee the QoS profile for the QoS Flow transporting PDU Sets.

19. The apparatus of claim 15, wherein:
the first network element is a Radio Access Network; and
the second network element is a core network element.

20. An apparatus for wireless communication at a first network element, comprising:
one or more memories; and
one or more processors couple to the memory and configured to cause the first network element to:
receive an indication of a change in a bit rate or frame rate of a data flow between a second network element and a user equipment (UE);
establish one or more Quality of Service (QoS) parameters with a third network element to support the change in a bit rate or frame rate of the data flow in response to receiving the indication; and
provide to the UE a configuration message that configures one or more UE communication parameters to implement the established QoS parameters.

21. The apparatus of claim 20, wherein to establish QoS parameters with the third network element, the one or more processors are further configured to receive from the third network element a reference parameter of one of a plurality of Alternative QoS Profiles that were previously established with the third network element for a protocol data unit (PDU) set supporting the data flow.

22. The apparatus of claim 21, wherein the one or more processors are further configured to establish the plurality of Alternative QoS Profiles with the third network element as part of establishing the data flow to the UE, wherein each of the Alternative QoS Profiles is associated with a reference parameter and supports a particular bit rate or frame rate for a communication link between the first network element and the UE suitable for supporting the data flow.

23. The apparatus of claim 20, wherein the one or more processors are further configured to provide to the third network element a request for a reestablishment or update of the QoS parameters.

24. An apparatus for wireless communication at a first network element, comprising:
one or more memories; and
one or more processors coupled to the one or more memories and configured to cause the first network element to:
obtain an indication of a change in a bit rate or frame rate of a data flow; and
establish one or more Quality of Service (QoS) parameters with a second network element to implement the change in the bit rate or frame rate.

25. The apparatus of claim 24, wherein the one or more processors are further configured to establish QoS parameters with the second network element by providing to the second network element a reference parameter of one of a plurality of Alternative QoS Profiles that were previously established with the second network element for a protocol data unit (PDU) set supporting the data flow.

26. The apparatus of claim 25, wherein the one or more processors are further configured to establish the plurality of Alternative QoS Profiles with the second network element as part of establishing the data flow to a user equipment (UE), wherein each of the Alternative QoS Profiles is associated with an identifier and supports a particular bit rate or frame rate for a communication link between the second network element and the UE supporting the data flow.

27. The apparatus of claim 24, wherein the one or more processors are further configured to cause the first network element to:
receive from the second network element a request for a reestablishment or update of the QoS parameters; and
adjust the bit rate or frame rate for the data flow related to the request for reestablishment or update of the QoS parameters.
